(19) United States
(12) Patent Application Publication
(10) Pub. No.: US 2002/0152147 A1
(43) Pub. Date: Oct. 17, 2002

(54) System and method for interest-based data management

(76) Inventors: John Gordon Shulman, Waubun, MN (US); Jeanne-Marie Almonor, Waubun, MN (US); Julien Paul Almonor, Palm Harbor, FL (US); Richard Ridell DaCosta, Newton, MA (US); Vikram Arvind Wagh, Chembur (IN)

Correspondence Address: PERKINS, SMITH & COHEN LLP, ONE BEACON STREET, 30TH FLOOR, BOSTON, MA, 02108, US

(21) Appl. No.: 09/836,571

(22) Filed: Apr. 17, 2001

(51) Int. Cl. G06F 17/60

(52) U.S. Cl. 705/35

(57) ABSTRACT

The present invention is a computer-implemented tool for strategy planning, risk analysis, and negotiations. It is an interest-based information management system that organizes information about the interests of various stakeholders in a planning session or negotiation on issues relevant to the stakeholders. The tool enables users to evaluate information in complex decisions. The tool is useful to decision-makers in evaluating possible actions that will satisfy or harm their own interests to varying degrees and that will satisfy or harm the interests of other stakeholders to varying degrees. The tool manages a large amount of information and brings rigor, discipline and consistency to the decision analysis process. The system enables decision-makers to develop and evaluate action plans for satisfying their interests through a negotiated agreement and develop and evaluate fighting alternatives for satisfying their interests in the absence of a negotiated agreement.

### FIELD OF THE INVENTION

This invention relates generally to data management and more particularly to management of data and relationships between data in a strategy planning, risk analysis and negotiations resolution system.

### BACKGROUND OF THE INVENTION

Negotiation is a process where two or more stakeholders with varying, sometimes conflicting objectives attempt to meet their objectives through an agreement. Negotiation may involve stakeholders whose objectives are in direct conflict with each other or stakeholders whose objectives are more compatible. Stakeholders whose objectives are largely compatible often engage in a process of negotiation that seeks to meet their objectives through strategy planning. Whether the objectives of stakeholders are in direct conflict or largely compatible, negotiation occurs whenever stakeholders attempt to reach agreement on proposals or strategies for meeting their objectives. Negotiation is often aided by the participation of a neutral mediator, or facilitator, who can assist the stakeholders in attempting to reach agreement, particularly where the objectives of the stakeholders appear to be in direct conflict.

Strategy planning occurs in negotiations through a process of risk analysis as each stakeholder evaluates its own objectives and proposals for meeting those objectives as well as proposals for meeting the objectives of other stakeholders. The negotiation process therefore includes not only bargaining-the presentation and exchange of proposals for meeting stakeholders' objectives-but also the attempts by each stakeholder to discover, evaluate and use knowledge of the preferences, strengths and weaknesses of their counterparts to reach an acceptable negotiated resolution. Strategy planning and negotiations also involve an evaluation of alternatives to negotiated resolution in the event the stakeholders are unable to reach agreement. Negotiating stakeholders may be individuals, interest groups, corporations or other organizations.

A negotiator, herein defined as a participant in the negotiation process, must navigate the available data about the stakeholders and their conflicting objectives and explore alternative solutions that may meet those objectives. Negotiators must identify and evaluate the consequences of various possible decisions, and begin to understand the tradeoffs among these consequences. They need to determine, for each proposed solution to the conflict, what each stakeholder will get, and what, if anything, the stakeholders will have to give up, and whether or not what they get will be worth more than what they will lose. This process of risk analysis, which may be aided by the participation of a mediator, is central to the negotiator's strategy planning. The process of risk analysis may be performed by an individual negotiator alone, by a group of negotiators together, by negotiation adversaries together or apart, or by mediators or other neutral facilitators who seek to assist the negotiators.

The identification and analysis of factors in negotiation and conflict resolution are data intensive, particularly in complex negotiations involving more than two stakeholders and multiple issues. In a negotiation, each stakeholder has its own context, interests, positions and values. These factors may be strategic, psychological, or institutional.

Context is defined here as the background of a stakeholder, the relationships that stakeholder has with the other stakeholders involved in or affected by the negotiation, and the issues that are relevant to the negotiation.

Interests are a stakeholder's needs and/or desires. An interest can also be defined as the stakeholder's desired outcome with respect to a particular issue. A position is the proposal or stand a stakeholder takes in order to satisfy its interests. In other words, a position is what the stakeholder proposes during a negotiation so that its interests will be satisfied. Negotiating positions are often related to but distinct from a negotiator's underlying interests. For example, in a negotiation between a parent and a school district regarding admission of a child to school, the parent may take the position that the child should be admitted to one specific school in the district in order to satisfy the parent's interest in having her child attend a good school. (If there were another good school offered by the district, then the parent could compromise her negotiating position by accepting the other school without harming her interest in having her child attend a good school.)

In addition to having context, interests, and positions, different stakeholders place different values on these things. One relationship may be more valuable than another. One interest may be relatively inconsequential while another may be critical. If a negotiator understands the relative priority of a relationship or importance of an interest, it can be easier to evaluate possible tradeoffs that may result in small harm to certain, less important interests but large benefits for other, more important interests.

In order to perform an effective risk analysis and develop successful negotiation strategies, the negotiator must track each of these factors on an ongoing basis. Before and throughout a negotiation, the negotiator must ask with regard to the stakeholders, “What do they want, why do they want it, and how much do they want it?” Tracking these factors is generally complex given that factors change over the course of the negotiation.

It has been discovered that negotiation strategies and conflict resolution focusing on interests are more successful than other strategies and forms of conflict resolution that focus on stakeholders' negotiating positions, which often result in impasse. To be considered successful, a negotiated agreement must be durable, and satisfied interests are the building blocks of lasting agreements. The successful negotiator must be able to examine and analyze alternatives in view of the stakeholders' interests and how each interest may be affected in light of each proposed solution. The alternatives may have a wide range of consequences on the interests of various stakeholders, including short-term and long-term consequences, which the negotiator must take into account.

It remains desirable to have a tool for tracking stakeholders, contexts, interests, possible negotiation proposals, alternatives to negotiated resolution, and the consequences of those proposals and alternatives on the interests of the stakeholders before and during the course of a negotiation.

It is an object of the present invention to provide a method and apparatus to manage data for strategy planning, risk analysis and negotiations according to the interests of the stakeholders.

It is another object of the present invention to provide a method and apparatus to efficiently track alternatives to possible negotiated agreements.

It is another object of the present invention to provide a method and apparatus to organize and display data about the interests of the stakeholders, the relationship of those interests to each other, associated values of each stakeholder in a negotiation, and the consequences of various possible courses of action in order to determine optimum outcomes.

### SUMMARY OF THE INVENTION

The problems of managing data for strategy planning, risk analysis and negotiations are solved by the present invention of a system and method for interest-based data management.

The present invention is a computer-implemented tool for strategy planning, risk analysis, and negotiations. For simplicity, strategy planning sessions, risk analysis sessions, and negotiations are also referred to as “transactions.” The present invention is an interest-based information management system that organizes information about the interests of various stakeholders in a negotiation or planning session on issues relevant to the stakeholders. In the present invention, a stakeholder may be an individual person, a group of people, an organization or a legal entity. In sum, a stakeholder may be any entity having issues and interests in a transaction as described herein. The tool enables decision-makers and mediators to evaluate information about the interests of the stakeholders so that various strategies may be considered for their effects on those interests. The tool is useful to decision-makers in evaluating actions that will satisfy or harm their own interests and that will satisfy or harm the interests of other stakeholders to varying degrees. The tool manages a large amount of information and brings rigor and consistency to the strategy planning, risk analysis and negotiation processes.

The system enables decision-makers to formulate and evaluate various possible action plans for satisfying their interests through a negotiated agreement or through fighting alternatives in the absence of a negotiated agreement. The system also enables mediators, or neutral facilitators, to assist decision-makers to formulate and evaluate various possible action plans for satisfying stakeholder interests through a negotiated agreement or through fighting alternatives in the absence of a negotiated agreement. The system may be used by one negotiator, by a group of negotiators at the same time, by negotiation adversaries together or separately, or by a mediator or other neutral facilitator, all with or without the direct participation of other stakeholders. The method is as follows.

First, the users identify a planning session, an analysis session, or negotiation, i.e., a transaction. The users then identify all stakeholders in the transaction and all issues relevant to those stakeholders. The interests of each stakeholder with regard to each issue are identified. An issue is a component of a transaction. The relationship of each stakeholder's interests to the interests of other stakeholders and the importance of the interests to each stakeholder are identified. The data is entered into the system.

Second, actions that could be taken to satisfy the interests of one or more stakeholders are identified and evaluated. These actions could be part of a negotiated resolution belonging to all stakeholders involved. Not every stakeholder may be able to take every action, but all possible actions that could satisfy the interests of the stakeholders through a negotiated resolution are identified. The users determine how the interests of each of the stakeholders, including the users' own interests, will be affected by each of the possible actions.

Third, the users identify fighting alternatives for each stakeholder if a negotiated agreement is not achieved. The fighting alternatives include 1) alternatives that unilaterally satisfy the interests of stakeholders (i.e., they do not require agreement by other stakeholders), and 2) alternatives that harm the interests of other adversarial stakeholders who are essential for a negotiated resolution. The users determine how the interests of each of the stakeholders, including the users+ own interests, will be affected by fighting alternatives. This information is maintained in a provisional fighting alternatives plan for each stakeholder in the planning session or negotiation.

Fourth, the users consider a variety of possible actions from the second phase that can be included in action plans for a negotiated agreement. In deciding which possible actions to include in the action plans, the users can select from a menu of negotiation strategies identifying sets of actions that yield varying levels of satisfaction or harm to the interests of specified stakeholders chosen by the users. In addition, the users can modify the provisional fighting alternatives plans or create new fighting alternatives plans for some or all stakeholders. The users can then compare the degree of satisfaction and harm that the selected action plans will bring to the interests of the stakeholders against the degree of satisfaction and harm the fighting alternatives identified in the fighting alternative plans will bring in order to determine whether each stakeholder will be better off agreeing to the negotiation proposals of the specified action plan or pursuing its independent fighting alternatives. If any stakeholder would be better off pursuing its fighting alternative plan, then the users may consider whether the specified action plan should be improved from the perspective of that stakeholder so as to make a negotiated agreement more attractive for that stakeholder. In addition, the users can further refine the issues, stakeholders, context and stakeholder values, possible actions and action plans, refine the fighting alternative actions and fighting alternative plans, re-evaluate the interests of the stakeholders, and re-evaluate the effects of the possible actions and fighting alternatives on those interests. The foregoing may be done on an unlimited basis until the users are satisfied with their analyses.

The data collected and analyzed in the above method is collected, related and displayed such that the interests of the stakeholders and the relationships among those interests, including areas of commonality and divergence among the stakeholders, are easily identified. Similarly, the values placed by stakeholders on their interests, including the interests with higher values, are easily identified.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of an interest-based data management system according to principles of the invention;

FIG. 2 is a block diagram of a computer network capable of operating according to the principles of the present invention;

FIG. 3 is a flow chart of the method of high-level of operation of the interest-based data management system of FIG. 1;

FIG. 4 is a flow chart of the method of establishing a planning session or negotiation using the interest-based data management system of FIG. 1;

FIG. 5 is an interest chart resulting from the method of FIG. 4;

FIG. 6 is a flow chart of the method of determining actions using the interest-based data management system of FIG. 1;

FIG. 7 is a Possible Actions List resulting from the method of FIG. 6;

FIG. 8 is a flow chart of the method of determining fighting alternatives using the interest-based data management system of FIG. 1;

FIG. 9 is a Stakeholder Fighting Alternatives List;

FIG. 10 is a flow chart of the method of developing an action plan using the data generated in the methods of FIGS. 4, 6, and 8;

FIG. 11 is the interest chart of FIG. 5 further modified after the method of FIG. 10; and

FIG. 12 is the interest chart of FIG. 4 further including the effects of the fighting alternative plans applied according to principles of the invention.

### DETAILED DESCRIPTION OF PREFERRED EMBODIMENTS

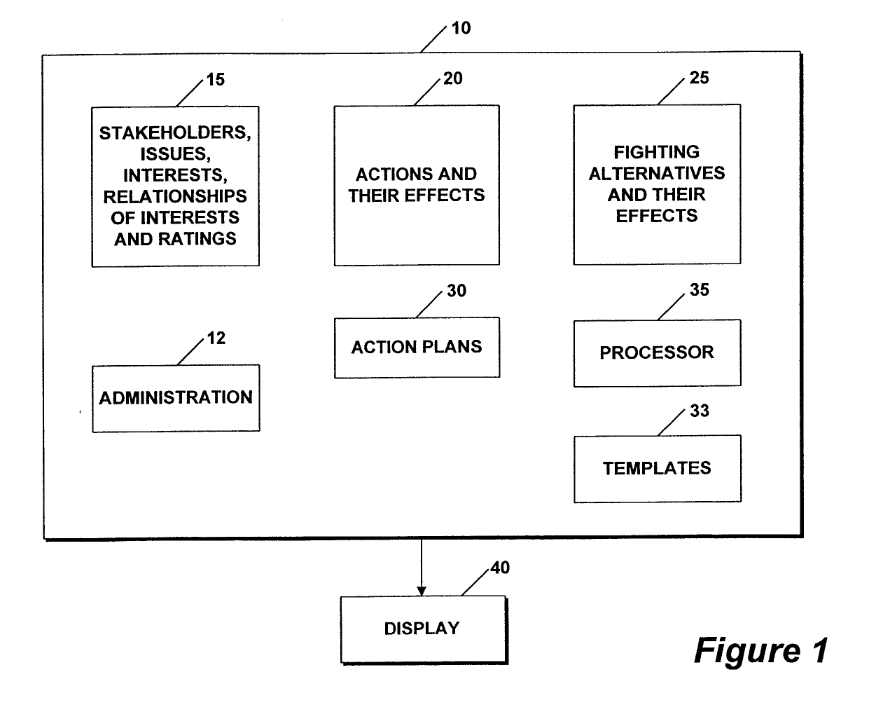

FIG. 1 shows the interest-based data management system 10 of the present invention. The system has a plurality of databases. An administration database 12 holds the user groups, passwords, confidentiality data, and session identification. The users of the system can designate levels of access to data in the system for specified individual users or groups of users. In addition, specified sessions, parts of sessions, or related versions of sessions may be designated confidential so that access to such data is restricted, even to stakeholders involved in a session or to members of a user group. A stakeholders database 15 holds the stakeholders, the issues relevant to the stakeholders, and the interests of the stakeholders on the issues. The interests are rated in importance to the stakeholders. Those stakeholders who have a larger interest or who are most important in a strategic planning session or a negotiation are identified. The actions database 20 holds the potential actions that may be taken. The stakeholders and their issues and interests are linked together. Associations between actions and stakeholders, that is, the effects of the actions on stakeholder interests, are indicated.

The fighting alternatives database 25 holds fighting alternatives to be taken in the event that a stakeholder encounters difficulties in the planning session or negotiation or is unable to achieve an acceptable negotiated agreement. The fighting alternatives database also holds fighting alternative plan prediction formulas to help the users determine likely actions of other stakeholders and to help the users design an efficient course of action. The databases and fighting alternative plan prediction formulas will be described in greater detail below. The plans database 30 holds the negotiation plans or possible negotiated agreements and all the iterations of them as they are developed while the system is used, as well as the default fighting alternatives plans for each stakeholder and any iterations of fighting alternative plans developed as the system is used. The actions database also holds negotiation strategy formulas to help the users identify combinations of possible actions that would yield negotiation outcomes acceptable to the users and, if possible, to other stakeholders. The databases and negotiation strategy formulas will be described in greater detail below. A templates database 33 stores templates of data that can be used for negotiations and planning sessions. The stored templates can include user-generated templates and also industry and application specific templates. A models database stores data from previous planning sessions and negotiations that can be used for future negotiations and planning sessions. The databases are shown here as separate, however all the databases may be organized as one within the scope of the invention. Alternatively, the databases shown here may be further broken down within the scope of the invention.

A processor 35 analyzes the data, including the consequences of actions and fighting alternatives within the framework of a planning session or negotiation, and organizes the displays of data. Further operation of this component is found throughout the specification. Over the course of operation of the system, the system provides displays of tables of data and the results of data manipulation and the developing fighting alternative plans and negotiation plans or possible negotiated agreements on a display component 40.

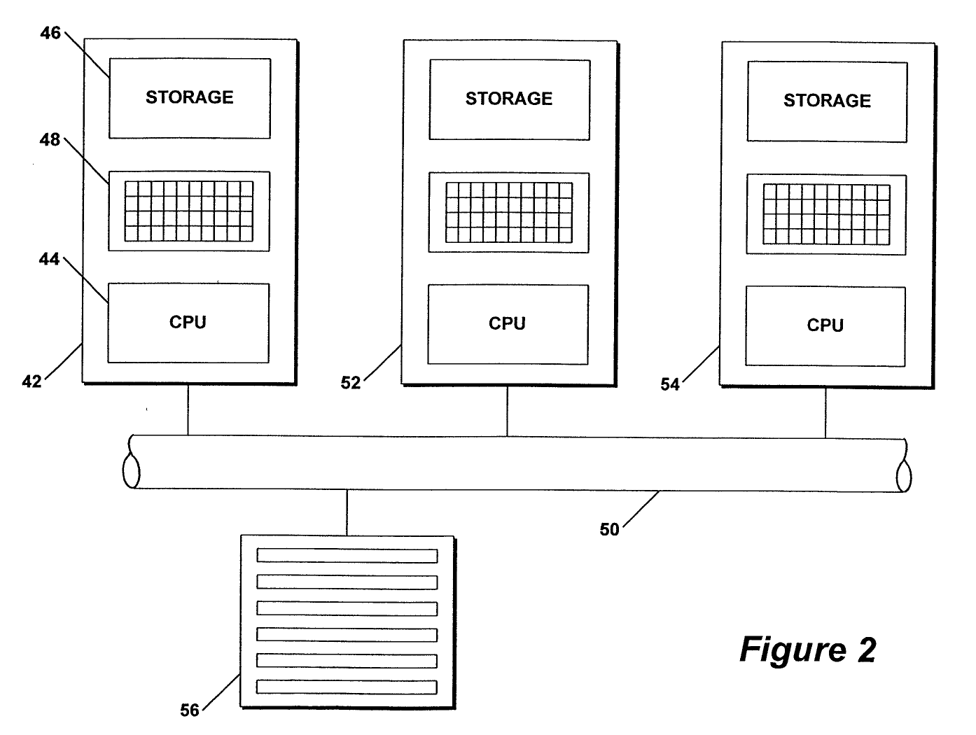

FIG. 2 is a diagram of a network capable of operating according to principles of the present invention. A first computer system 42 is connected to a second computer system 52 and a third computer system 54 across a network 50. Also attached to the network is a remote storage device 56. Each computer system has for example, a CPU 44, a memory device 48 and a storage device 46 as shown in the first computer system 42. The present invention is capable of being used as a standalone device or as a device connected over a network such as the computer system 42. Alternatively, the present invention may be operated in a distributed manner among a plurality of computer devices including a remote storage device 56 to store some or all of the data described in relation to FIG. 1. The network 50 may be a local area network, a wide area network, the Internet or any other type of network capable of communicating data.

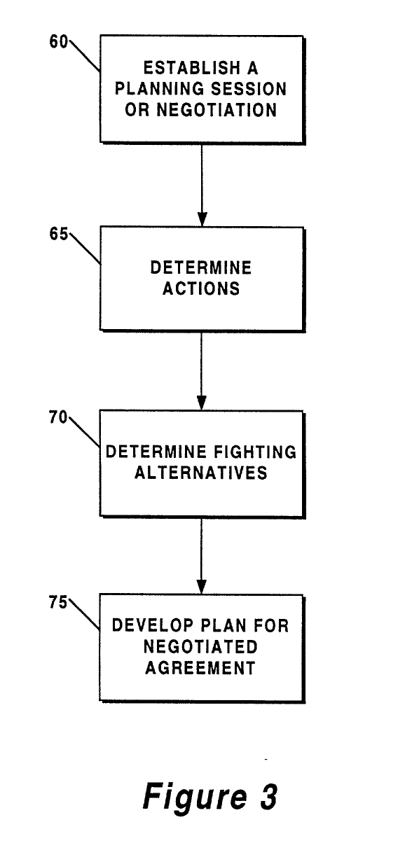

FIG. 3 is a flow chart of the high-level operations of the present invention. First, a negotiation or planning session is established with stakeholders, issues and stakeholder interests identified, block 60. Then possible negotiation actions are determined, block 65. Then fighting alternatives are determined, block 70. Finally, negotiation plans or possible negotiated agreements are developed, and fighting alternative plans are developed and refined, block 75. Processes in each of these four phases are iterated until the users stop or arrive at a satisfactory solution.

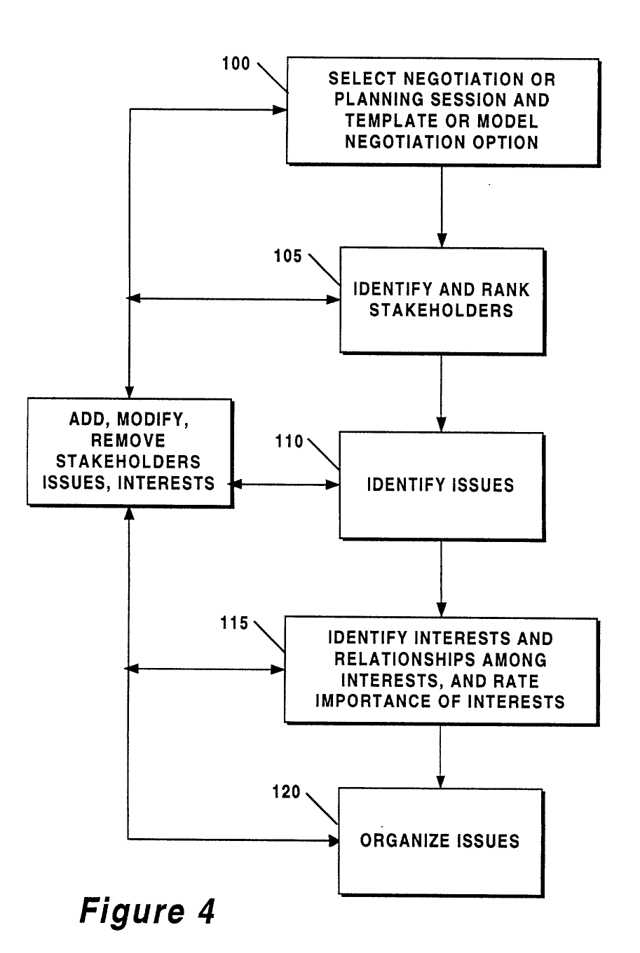

FIG. 4 is a flow chart of the first phase of operation of the system, establishing a planning session or negotiation with stakeholders, issues and stakeholder interests identified. In establishing a planning session or negotiation, the users first declare whether the event is a new planning session or the resumption of an existing planning session, block 100. If the users attempt to resume a planning session or negotiation, the users must be authorized through a user ID and password to access that session or negotiation. An administrator or primary user of the system determines who can access which sessions or negotiations. Access to a session can be restricted to an individual stakeholder using the system alone, to a user group within an organization that acts as one stakeholder in a planning session or negotiation, to multiple stakeholders in a planning session or negotiation, including negotiation adversaries, or to a mediator or other neutral. In addition, the administrator or primary user can restrict access to all or part of the data in a session or negotiation for specified users by designating such data confidential.

Stakeholders who are allowed access to a planning session or negotiation can work separately on different but related versions of the same session or negotiation, or they can work together on one unified version of the session or negotiation. At any time, users authorized to do so by the administrator or primary user can split a session or negotiation into separate, related sessions. If a session or negotiation is split into two or more related sessions, all of the data from the original session or negotiation is ported into the new, related sessions, where it can be modified separately by the users authorized to access each new session.

In addition, users authorized to do so by the administrator or primary user can merge the data from separate sessions or negotiations into a single, unified session or negotiation. If requested to do so by authorized users, the system can merge the data from separate sessions or negotiations into a single, unified session by porting into the merged session or negotiation all of the data from the separate sessions or negotiations, where it can be modified separately by the users authorized to access the merged session or negotiation. Whereas all data that is identical from the separate sessions is ported unadulterated into the new, merged session, other data that is not common to the separate sessions is highlighted for the users when it is ported into the merged session. The system uses different types of highlighting for different types of inconsistent data. Where separate sessions include inconsistent data regarding stakeholder interests, the system recommends the data provided by the stakeholder for whom the interest is indicated, if that stakeholder has provided such data. Other than in the above example of a stakeholder providing data regarding its own interests, the system expresses no preference for any version of inconsistent data and instead ports all such inconsistent data into the new merged session or negotiation so that the users can select, modify or delete inconsistent data in the users+ discretion.

If the users are starting a new planning session, the users also choose whether or not to use a template or model negotiation and if a template or model negotiation is desired, which one to use. A template contains data that has been previously stored for use in subsequent planning sessions or negotiations. The data can include information about particular stakeholders, issues, stakeholder interests, negotiation actions or negotiated agreements, fighting alternatives, fighting alternative plans, action plans, and the effects of actions, fighting alternatives, action plans and fighting alternative plans on the interests of stakeholders. Templates can be created for specific users, groups of users, or types of users, such as users within a particular avocation or industry. The data from templates can be ported into a new planning session or negotiation. A model planning session or negotiation contains a complete set of data from a previous planning session or negotiation that has been stored by the users or has been provided with the system. Model negotiations can be provided for specific users, groups of users, or types of users, such as users within a particular avocation or industry. The users can decide to use some or all of the data from templates and model planning sessions or negotiations in the new planning session or negotiation.

After a new planning session or negotiation has been given a description or title by the users, then the users identify all stakeholders, block 105. The stakeholders may be organizations, groups or individuals. The users identify groups of stakeholders who are likely to have the same interests on all issues and name each group so that the group-rather than each individual stakeholder-will appear on an interest chart. The users also identify stakeholders related to other stakeholders who may have interests that diverge from those of the other related stakeholders so that each such stakeholder can appear individually on an interest chart. The system uses the above data to determine whether stakeholders appear on an interest chart. The users identify all stakeholders who are essential to a decision or negotiated resolution and then rank the essential and non-essential stakeholders by the importance of each stakeholder to the planning session or to resolution of the negotiation or by the order in which the users would like the stakeholders to appear on an interest chart. The system uses this data to determine the order in which the stakeholders appear on the interest chart. All stakeholders that are identified as essential appear first on the interest chart. The users select the order in which the essential stakeholders appear on the interest chart, generally (but not necessarily) beginning with the users themselves and continuing in order of the importance of each essential stakeholder to the planning session or negotiation. The stakeholders that are identified as non-essential appear on the interest chart after the essential stakeholders in the order selected by the users, again usually (but not necessarily) in order of their importance.

The users then identify all issues relevant to those stakeholders, block 110. The users identify every issue that is relevant to any of the stakeholders involved in or affected by the planning session or negotiation. There is no limit to the types of issues the users can identify. A list of possible issues is provided to the user to assist the user in identifying issues that may be relevant to the stakeholders. This list includes, but is not limited to, some or all of the following: access, access to customers, access to products, accountability, accounting, advancement, agreements, alliances, appeals, approvals, arbitration, attorneys fees, authority, avoid conflict, benefits, bankruptcy, branding, capital, cash flow, choices, commissions, communication, compensation, competition, continue fighting, clarify roles, co-branding, confidence, confidentiality, consistency, contracts, control, cost, co-workers, create conflict, credit, curtail relationship, delay, discipline, discrimination, discount, discounting, dissolution, distance, distribution, duration, education, efficiency, ending, entry barriers, environment, expand relationship, expansion, expectations, finality, finances, financing, flexibility, foreclosure, foreseeability, formal agreement, formats, forum, funding, future, good will, government approvals, growth, harassment, indemnification, infrastructure, injunction, inspections, inventory, investment, job description, judicial decision, justice, language, legality, liability, licensing, limit exposure, limit damage, management, margins, market access, market share, marketability, mediation, misunderstanding, money, monopoly, partners, past, pay money, personnel, placement, policies, pollution, positioning, predation, predictability, present prestige, price, probation, profit, profitability, promotion, product, productivity, publicity, public relations, publication, quality, quality assurance, ranking, receive money, relationship, reliability, representation, representatives, reputation, resolve conflict, resolve dispute, respect, responsibility, revenge, royalties, rules, save time, settlement, supervision, supervisors, surprise, suspension, technology, time, timing, trade secrets, trust, understanding, waste time. In addition, as the users use the system, the system stores and adds issues that the users enter to the list of possible issues. The list of possible issues may be modified, or customized, by the users, and may be displayed, in the preferred embodiment, through a dropdown box.

After the stakeholders and issues are identified, the users identify stakeholder interests, block 115. The users identify the interests of each stakeholder on every issue. It is possible for a stakeholder's interest to be unknown or for the issue to be inapplicable to that stakeholder. In the case of an issue on which the stakeholder's interest is unknown, the cell in the interest chart that corresponds to the intersection of that issue in relation to that stakeholder displays a question mark. In the case of an issue that is inapplicable to the stakeholder, the cell in the interest chart that corresponds to the intersection of that issue in relation to that stakeholder displays that the issue is not applicable to that stakeholder. When identifying interests, the users can select from a menu of possible interests or type in an interest. There is no limit to the type of interests the users may identify for each stakeholder on each issue. Examples of interests that may be provided by the system include but are not limited to: yes, no, high, low, increase, reduce, improve, undermine, asap, not applicable, and unknown. The system can store interests identified by the users and add them to the menu. The menu of interests may be modified, or customized, by the users, and may be displayed, in the preferred embodiment, through a drop-down box. In addition, the system can anticipate possible interests that the users have identified earlier and propose those interests based on the initial character or characters typed in by the users when the first characters of an interest are typed in by the users. For interests other than not applicable and unknown, the users may select from three levels of importance: critical, important, or not important. In alternative embodiments of the invention, other types of rankings may be used. Also further gradations in ranking may be used within the scope of the invention.

When identifying interests, the users must identify relationships between the interests of different stakeholders on each issue, so that interests of stakeholders can be identified as being the same on some issues, opposite on some issues, and different but not opposed to each other on some issues. In order for the system to determine the relationship of the interests of different stakeholders, the users must first identify the interest of an anchor stakeholder on each issue. The anchor stakeholder can be any stakeholder who has an interest other than not applicable or unknown on that issue. Once an anchor stakeholder's interest has been identified, the users identify the interests of the other stakeholders on the same issue relative to that anchor stakeholder's interest. The other stakeholders' interests can be the same as the anchor interest, the opposite of the anchor interest, different from but not opposite the anchor interest, not applicable, or unknown.

The determination of the interests of the stakeholders on each issue creates links among the stakeholders. The issues are then organized and displayed on an interest chart so as to emphasize issues on which stakeholders have common interests and issues on which the interests of the stakeholders diverge or are directly opposed to each other, block 120. The users may preview the interest chart as soon as some but not all of the stakeholder interests have been identified. In addition, the users may choose to identify some but not all of the stakeholder interests on each issue, or identify no interests at all on some issues. If particular stakeholder interests are not identified, those interests appear on the interest chart as not yet identified. At any point in a negotiation or planning session, stakeholders, issues and interests may be added, modified, or removed.

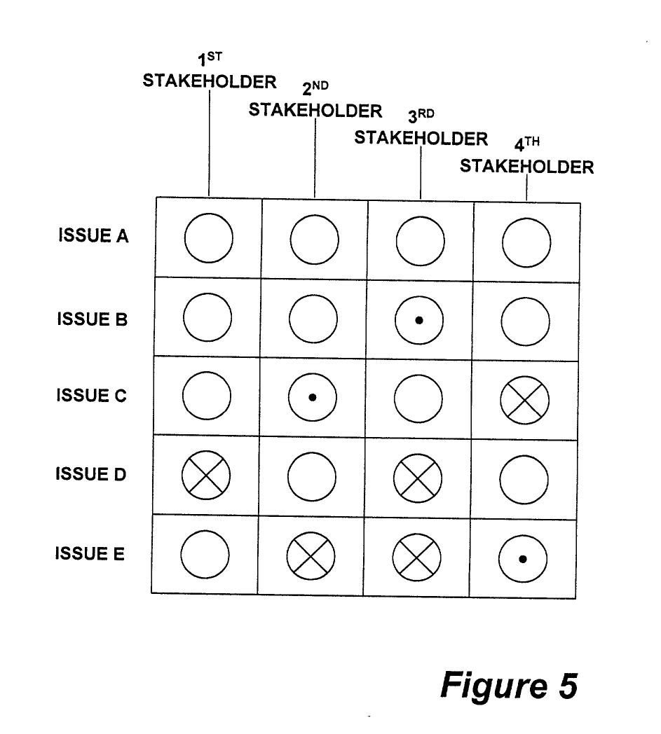

FIG. 5 shows an interest chart resulting from the first phase of the operation of the system. As they are organized and displayed, the issues can be understood generally on a continuum, or hierarchy, of the following:

Issues that facilitate agreement: These are issues where all or virtually all stakeholders, particularly essential stakeholders, have the same interest and invite “win-win” negotiation actions that will satisfy the interests of most stakeholders and therefore build negotiating momentum. These issues are placed at the top of the interest chart and are often the first issues on which negotiators may focus.

Issues of probable agreement: These are issues where many essential stakeholders have the same critical and important interests. These issues invite actions that will satisfy the critical and important interests of those essential stakeholders, even though the actions may harm the interests of other stakeholders. These issues, which appear on the interest chart below the issues that facilitate agreement, encourage the formation of alliances among stakeholders with common interests as negotiating momentum builds.

Issues that pose a challenge: These are issues where essential stakeholders have diametrically opposed interests. These interests pose a special challenge to the negotiating process. These issues, appearing at the bottom of the interest chart, are often best addressed last, after negotiating momentum has grown on other issues to the point that essential stakeholders may consider the benefits of an emerging negotiated agreement as a whole, rather than focusing on these most difficult issues first or in isolation.

The system uses the assignment of points in the following formula for evaluating all of the stakeholder interests on each issue to determine where to place that issue on the interest chart:

A. Every critical interest on the issue that is the same as the anchor interest is given a value of 7;

B. Every important interest on the issue that is the same as the anchor interest is given a value of 5;

C. Every unimportant interest on the issue that is the same as the anchor interest is given a value of 1;

D. Every critical interest on the issue that is the opposite of the anchor interest is given a value of −7;

E. Every important interest on the issue that is the opposite of the anchor interest is given a value of −5;

F. Every unimportant interest on the issue that is the opposite of the anchor interest is given a value of −1;

G. Every interest noted above that is the interest of an essential stakeholder is multiplied by 5;

H. The interests identified in A-C above are added together for a sum total value of all interests on the issue that are the same as the anchor interest;

I. The interests identified in D-F above are added together for a sum total value of all interests on the issue that are the opposite of the anchor interest;

J. The sum total values of H and I above are added together to determine an integer representing the interest chart value for the issue (if the sum total values of H and I are a negative integer, then the interest chart value for the issue is determined by converting that negative integer to a positive integer);

K. Every critical interest on the issue that is different from but not opposite the anchor interest is given a value of 7;

L. Every important interest on the issue that is different from but not opposite the anchor interest is given a value of 5;

M. Every unimportant interest on the issue that is different from but not opposite the anchor interest is given a value of 1;

N. Every interest noted in K-M above that is the interest of an essential stakeholder is multiplied by 5;

O. The interests identified in K-M above are added together for a sum total value of all interests on the issue that are different from but not opposite of the anchor interest;

P. The sum total value of O above is compared to the interest chart value of J above, and if O is greater than J, then the sum total value of O replaces the sum total value of J above as the interest chart value for this issue;

The issues are displayed on the interest chart with the issue that has the highest interest chart value at the top, and the other issues descending in the order of their interest chart values so that the issue with the lowest value is at the bottom.

In the case of issues with the same interest chart value, the following tie-breaker is used to determine the order such issues appear on the interest chart:

The issue with the most common interests among the stakeholders;

The issue with the most interests the same as the anchor interest;

The issue with the most interests different from but not opposite the anchor interest;

The issue with the most interests the opposite of the anchor interest;

The issue with the most critical and important interests;

The issue with the most critical interests;

The issue with the most important interests;

The order the issues were entered into the system for the planning session or negotiation.

In alternative embodiments of the invention, different formulas that organize the issues so as to emphasize different aspects of the relationships of interests to each other on the issues are possible.

Referring again to the chart of FIG. 5, a plurality of stakeholders are represented in the columns and a plurality of issues are represented in the rows. Each cell holds a symbol representing an interest for an issue (row) with respect to a stakeholder (column). The symbols here are: an open circle, a circle with an “x”, and a circle with a dot. Other symbols may be included as needed. There may be instances where there is no stakeholder interest or the stakeholder interest is unknown to the users. In those cases, a different symbol can be used to represent the inapplicable or unknown. Alternatively, the cell may be left empty. These instances would not affect the organization of the issues on the interest chart.

From top to bottom, the issues in the interest chart are organized on a continuum according to the frequency of common interests, with those issues on which common interests predominate at the top and those issues on which few interests are in common and many interests are opposed at the bottom. The issues toward the top indicate a greater likelihood that negotiation actions can be developed to satisfy many stakeholder interests, facilitating agreement. As the issues appear lower in the column, the symbols show that there are fewer stakeholder interests in common, and the likelihood of identifying negotiation actions that can satisfy most stakeholder interests on those issues becomes increasingly difficult, making agreement more difficult. In alternative embodiments of the invention, further gradation of issues and interests is possible. Also, alternate symbols are possible, for example representing the different types of interests with different colors or representing the importance of interests and relationships of interests to each other with different type fonts, geometric shapes and/or colors.

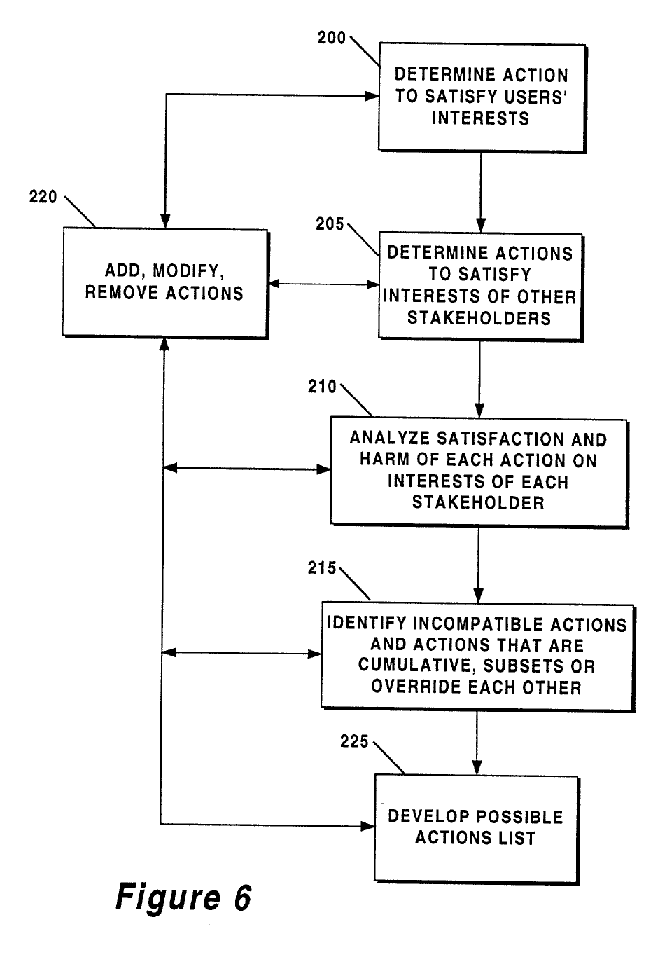

FIG. 6 is a detailed flow chart of the second phase, identifying negotiation actions. Actions that could be taken to satisfy the interests of one or more stakeholders are identified and refined. These actions could be part of a negotiated resolution belonging to all stakeholders involved. Not every stakeholder may be able to take every action, but the users identify all possible actions that could satisfy the interests of the stakeholders.

The users identify possible negotiation actions issue-by-issue, beginning with the issue at the top of the interest chart, unless the users select a different order of issues. On each issue, the users identify possible negotiation actions that could satisfy the users' interest, if applicable, and also identify possible actions that could satisfy the interests of other stakeholders on that issue, block 200.

The following questions are exemplary questions considered by the users in order to develop possible negotiated solutions: 1. What actions could be taken by any stakeholder that would satisfy the interests of a given stakeholder on each issue? 2. What actions could be taken by any stakeholder that would satisfy the interests of any other stakeholders that have different interests on an issue?

After the possible actions have been formulated and entered into the system, they are further categorized based on data input by the users in response to prompts from the system, block 210. Each possible action is categorized according to the following criteria: 1) What issues will be affected by each action; 2) Which stakeholders have interests satisfied by each action on each issue affected by the action and on a scale of one to ten, how much satisfaction each stakeholder derives from the action; and 3) Which stakeholders have interests harmed by each action on each issue affected by the action and on a scale of one to ten, how much harm each stakeholder suffers from the action. In alternative embodiments of the invention, different scales or measurements of satisfaction or harm may be used.

The system keeps track of this information about the effects of each action on stakeholder interests by maintaining a table of each action that records data of whether the action will satisfy, harm or have no effect on each stakeholder interest on each issue affected by the action. The system also tracks the level of satisfaction and harm of stakeholder interests by marking in the table of actions the level of satisfaction or harm caused by each action with regard to each stakeholder interest on each issue.

After the effects of the possible actions have been recorded, the possible actions are further categorized based on data input by the users in response to prompts from the system, block 215. Each possible action is further categorized according to the following criteria:

1) Whether any actions are incompatible with any other actions so that if one action occurs, the other action cannot occur; 2) Whether the effects of any combinations of actions on stakeholder interests are not cumulative so that if the non-cumulative actions occur, their effects are not aggregated; 3) Whether any actions are subsets of other actions so that if both occur, the effects of the actions on stakeholder interests are not taken into account separately; and 4) Whether any actions or combinations of actions are so potent that their effects on stakeholder interests override the effects of any other actions.

The system tracks in the table of actions described above this information about incompatible actions, non-cumulative effects of actions, actions that are subsets of other actions, and actions that override other actions. Each cell contains a record of data of the relationship between two actions. One entry in the record is an indication whether or not the actions being compared are compatible or incompatible with each other. Another entry in the record is whether or not the effects of the actions being compared are cumulative or not cumulative on each stakeholder interest on each issue. Another entry in the record is whether or not one of the actions being compared is a subset of the other action. Another entry in the record is whether or not the effects of one of the actions being compared overrides the effects of the other action on any stakeholder interests individually or in combination with any other actions.

The system keeps track of what combinations of actions are not cumulative so that their effects on stakeholder interests cannot be aggregated even if all actions in the non-cumulative combination occur. The system keeps track of what actions are subsets of other actions so that if both occur, the effects on stakeholder interests of only the larger of the actions are taken into account and the effects of the smaller action are not taken into account. The system keeps track of what actions or combinations of actions override other actions so that if overriding actions occur, the effects on stakeholder interests of the overriding actions are taken into account on issues on which the overriding actions override other actions, and the effects of the overridden actions are not taken into account.

When multiple actions are selected by the users for inclusion in an action plan, the system checks whether the actions are compatible, and if not, alerts the users to the incompatibility so that the users can decide which actions to include in the action plan. When the system calculates possible combinations of actions for inclusion in an action plan in response to strategies and criteria selected by the users, the system also checks whether the actions are compatible so that incompatible combinations of actions are not included in the action plan.

Similarly, when multiple actions are selected by either the users or the system for inclusion in an action plan, the system checks the actions table to determine whether actions are not cumulative, subsets or overrides and then calculates the aggregated values for satisfaction and harm from the selected combination of actions by adding for each stakeholder interest the level of satisfaction and subtracting the level of harm caused by each action that affects the issue subject to the data on non-cumulatives, subsets and overrides. When actions that are not cumulative on a given issue are included in a combination of actions for an action plan, the system selects for the calculation of aggregate effects on stakeholder interests the largest value integer (for the level of harm or satisfaction) from among the non-cumulative actions.

When a combination of actions is selected for inclusion in an action plan, the sum of satisfaction or harm values on each stakeholder interest for that action plan is therefore the aggregated effects from all cumulative actions in the action plan that cause satisfaction or harm of the particular stakeholder interest, excluding the satisfaction or harm caused by the smaller actions in subsets and by actions overridden by other actions.

The following describes how the system takes into account incompatible actions, non-cumulative actions, action subsets and action overrides when aggregating the effects of actions on stakeholder interests:

### Incompatibility

Actions that are incompatible cannot be combined at all in an action plan or other combination. If the users select incompatible actions for an action plan, the system will not accept both actions and will notify the users that the actions are incompatible. Similarly, the system will not include incompatible actions in any action plan generated by the system in response to selection of negotiation strategies by the users.

### Non-cumulatives

When two or more actions are not cumulative with each other, then the most extreme (i.e., highest integer) effect of the non-cumulative actions is added to the aggregated effects of the action plan on each issue for which the non-cumulative actions have an effect. That is, issue-by-issue, among the non-cumulative actions, the most extreme effect for that issue is included into the calculation of aggregate action plans. If two or more actions are designated non-cumulative, and on an issue at least one of the actions has a positive effect and other non-cumulative actions have a negative effect, then the users must select one of the non-cumulative actions to be included in the calculation of aggregate effects for that issue, or the users can re-designate the actions as cumulative for that issue so that more than one can be added.

For example, if there are three actions considered for an action plan with the following effects on a given issue:

Action A=Not cumulative with B, and Satisfy 5 (out of 10)

Action B=Not cumulative with A, and Satisfy 4; and

Action C=Harm 2

The effects of the above actions would be aggregated on a given issue as follows:

A=+5; B=+3; C=−2.

A is selected over B (because A has the higher value=+5), and A is added to C (which is cumulative):

A+C=5+(−2)=3

The total value for the aggregated effects of the three actions on this issue is therefore 3.

### Subsets

If Action A is a subset of Action B, and both A and B are selected for inclusion in an action plan, then Action B completely overrides Action A, and the only effects included in the action plan are the ratings from the effects of Action B. Action A, the subset of Action B in this case, becomes invisible whenever B is included in an action plan. (By contrast, if B is not included in an action plan, then A's ratings are added to the aggregated effects of the plan.) Subsets are overridden by the action of which they are a subset on every issue they affect.

For example, if there are 3 actions with the following properties:

Action A=Subset of B, and Satisfy 5 (out of 10)

Action B=Satisfy 7; and

Action C=Harm 2.

The following calculation shows how these actions would be added together on a given issue if all three were selected for an action plan:

A=Overridden as a Subset of B

B=+7

Plus

C=−2

Equals +5 (total effect of the actions on this issue)

### Overrides

Overrides are very similar to subsets mentioned above.

There are important differences, however, between overrides and subsets. First, unlike subsets, actions that override other actions may occur individually or in combination with other overriding actions. Second, unlike subsets (which cover all issues they affect), overrides must be identified issue-by-issue; they do not necessarily override other actions on every issue they affect. The users must therefore identify the issues on which a given action or set of actions overrides other actions. Third, overrides can override one action or multiple actions. The users must identify all actions that are overridden by other actions.

For example, if there are 4 actions with the following properties:

Action A=Overrides B when combined with C, and Satisfy 5

Action B=Overridden by combination of A and C, and Harm 3;

Action C=Overrides B when combined with A, and Satisfy 2

Action D=Harm 3.

The following calculation shows how these actions would be added together on a given issue if all three were selected for an action plan:

A=+5

B=Overridden by A and C

C=+2

D=−3

=5+2+(−3)

Equals +4 (total effect of the actions on this issue)

The users have an opportunity to return to any earlier part of the process in this phase of the system and repeat that part of the process, and may add, modify, or remove actions as the process continues, block 220. The users may also re-evaluate and modify the data regarding the effects of actions on stakeholder interests, including the data of incompatibles, non-cumulatives, subsets and overrides.

The system produces a Possible Actions List (PAL) as a result of the above data entered by the users about possible actions, block 225. The objective is to identify a wide range of options from which the users may select possible actions for action plans that will satisfy specified interests of specified stakeholders while minimizing harm to the critical and important interests of specified stakeholders, including the users themselves.

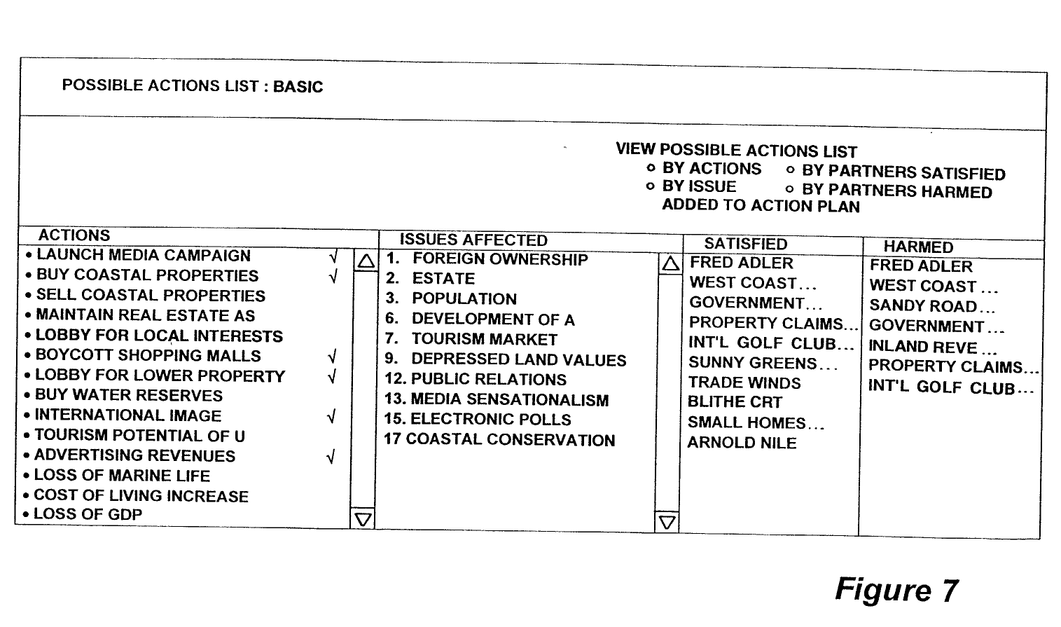

FIG. 7 shows a Possible Actions List. The Possible Actions List has four columns, an Actions column 250, an Issues Affected column 255, a Stakeholders Satisfied column 260, and a Stakeholders Harmed column 265. The Actions column 250 is the possible actions developed as described above. The Issues Affected column 255 is a list of all issues affected by any action selected by the users from the Actions column 250. The Stakeholders Satisfied column 260 lists all of the stakeholders satisfied by any action in the list selected by the users on any affected issue selected by the users. The Stakeholders Harmed column 265 lists all of the stakeholders harmed by a selected action from the list on a selected issue from the list. As the users select different actions, different sets of issues will appear in the issues column to show only those issues affected by the selected action. Similarly, as different issues are selected, only those stakeholders satisfied by the selected action on the selected issue will appear in the Stakeholders Satisfied column. The same principle applies to the stakeholders appearing in the Stakeholders Harmed column. The order of the columns in the PAL can be changed by the users so that issues, stakeholders satisfied or stakeholders harmed will appear in the far left column followed by the actions in the column second from the left.

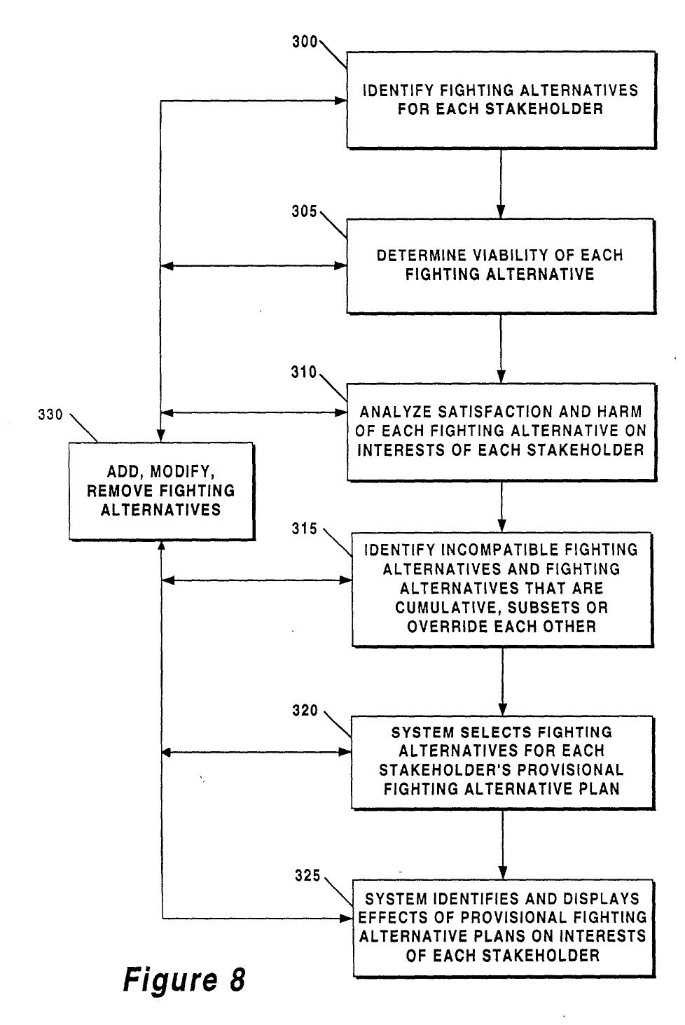

FIG. 8 shows a flow chart of the third phase of operation of the system where the users identify fighting alternatives for each stakeholder if an acceptable plan of action or a negotiated agreement is not achieved. The users determine how the interests of the stakeholders, including the users' own interests, will be affected by fighting alternatives. This information is maintained in a fighting alternative plan for each of the identified stakeholders in the planning session or negotiation.

The first step in creating a fighting alternative plan is to identify which stakeholders will be allies and which stakeholders will be adversaries if stakeholders pursue their fighting alternatives to a negotiated agreement. The users identify for each stakeholder all other stakeholders who are allies of that stakeholder and all stakeholders who are adversaries of that stakeholder if a negotiated agreement is not achieved. This data is recorded in a table with cells for each stakeholder. Each cell contains a record of data of the relationship between two stakeholders. One entry in the record is an indication whether or not the stakeholders being compared are allies with each other. Another entry in the record is whether or not the stakeholders being compared are adversaries with each other.

The second step is to identify the fighting alternatives of each stakeholder to determine what each stakeholder will likely do if the stakeholders do not reach an acceptable plan or a negotiated agreement, block 300. The users assess what fighting alternatives the stakeholders, including (if applicable) the users themselves, can take unilaterally on each issue to satisfy their own interests or harm the interests of other stakeholders who are adversaries of that stakeholder and are essential for a decision or a negotiated resolution. The users identify fighting alternatives for each stakeholder issue-by-issue, beginning with the users themselves (if applicable) and the issue at the top of the interest chart, unless the users select a different order of stakeholders or issues. The users enter this data into the system.

The following questions are exemplary questions considered by the users in order to identify fighting alternatives for each stakeholder: 1. What will this stakeholder likely do to satisfy its own interests unilaterally and to satisfy the interests of its allies on each issue if a negotiated resolution or decision is not achieved? 2. What will this stakeholder likely do to harm the interests of its adversaries who are essential to a negotiated resolution or decision on each issue if a negotiated resolution or decision is not achieved?

In the third step of developing the fighting alternatives for each stakeholder, the users evaluate the likelihood that each identified fighting alternative can be accomplished, block 305. The users predict the percentage likelihood that the fighting alternative will actually be attempted by the stakeholder and, if attempted, be successfully accomplished. The system keeps track of this information about the likelihood of success of each fighting alternative by maintaining a table for each stakeholder of the stakeholder's fighting alternatives that records data of the likelihood of success on each fighting alternative.

After the fighting alternatives for each stakeholder have been formulated and their likelihood of success has been entered into the system, the fighting alternatives are categorized based on data input by the users in response to prompts from the system, block 210. Each fighting alternative for each stakeholder is categorized according to the following criteria: 1) What issues will be affected by each fighting alternative; 2) Which stakeholders have interests satisfied by each fighting alternative on each issue affected by the fighting alternative and on a scale of one to ten, how much satisfaction each stakeholder derives from the fighting alternative; and 3) Which stakeholders have interests harmed by each fighting alternative on each issue affected by the fighting alternative and on a scale of one to ten, how much harm each stakeholder suffers from the fighting alternative. In alternative embodiments of the invention, different scales or measurements of satisfaction or harm may be used.

The system keeps track of this information in the above table for each stakeholder's fighting alternatives that records data of whether the fighting alternative will satisfy, harm or have no effect on each stakeholder interest on each issue affected by the fighting alternative. The system also tracks the level of satisfaction and harm of stakeholder interests by marking in the table of each stakeholder's fighting alternatives the level of satisfaction caused by each fighting alternative with regard to each stakeholder interest on each issue.

After the effects of each stakeholder's fighting alternatives have been recorded, the fighting alternatives are further categorized based on data input by the users in response to prompts from the system, block 215. Each fighting alternative is further categorized according to the following criteria:

1) For each stakeholder, whether any of that stakeholder's fighting alternatives are incompatible with any other of that same stakeholder's fighting alternatives so that if one fighting alternative occurs, the other fighting alternative cannot occur;

2) For all fighting alternatives of all stakeholders collectively, whether the effects of any combinations of fighting alternatives on stakeholder interests are not cumulative so that if the non-cumulative fighting alternatives occur, their effects are not aggregated;

3) For all fighting alternatives of all stakeholders collectively, whether any fighting alternatives are subsets of other fighting alternatives so that if both occur, the effects of the fighting alternatives on stakeholder interests are not taken into account separately; and

4) For all fighting alternatives of all stakeholders collectively, whether any fighting alternatives or combinations of fighting alternatives are so potent that their effects on stakeholder interests override the effects of any other fighting alternatives.

The system tracks in the table of each stakeholder's fighting alternatives described above this information about incompatible fighting alternatives, non-cumulative effects of fighting alternatives, fighting alternatives that are subsets of other fighting alternatives, and fighting alternatives that override other fighting alternatives. Each cell contains a record of data of the relationship between two fighting alternatives. One entry in the record is an indication whether or not the fighting alternatives being compared are compatible or incompatible with each other. Another entry in the record is whether or not the effects of the fighting alternatives being compared are cumulative or not cumulative on each stakeholder interest on each issue. Another entry in the record is whether or not one of the fighting alternatives being compared is a subset of the other fighting alternative. Another entry in the record is whether or not the effects of one of the fighting alternatives being compared override the effects of the other fighting alternative on any stakeholder interests individually or in combination with any other fighting alternatives.

The system keeps track of what combinations of fighting alternatives are not cumulative so that their effects on stakeholder interests cannot be aggregated even if all fighting alternatives in the non-cumulative combination occur. The system keeps track of what fighting alternatives are subsets of other fighting alternatives so that if both occur, the effects on stakeholder interests of only the larger of the fighting alternatives are taken into account and the effects of the smaller fighting alternative are not taken into account. The system keeps track of what fighting alternatives or combinations of fighting alternatives override other fighting alternatives so that if overriding fighting alternatives occur, the effects on stakeholder interests of the overriding fighting alternatives are taken into account on issues on which the overriding fighting alternatives override other fighting alternatives, and the effects of the overridden fighting alternatives are not taken into account.

When multiple fighting alternatives are selected by the users for inclusion in a stakeholder's fighting alternative plan, the system checks whether the fighting alternatives are compatible, and if not, alerts the users to the incompatibility so that the users can decide which fighting alternatives to include in the fighting alternative plan. When the system calculates possible combinations of fighting alternatives for inclusion in a stakeholder's provisional fighting alternative plan, the system also checks whether the fighting alternatives are compatible so that incompatible combinations of fighting alternatives are not included in the fighting alternative plan.

Similarly, when multiple fighting alternatives are selected by either the users or the system for inclusion in a stakeholder's fighting alternative plan, the system checks the fighting alternatives table for that stakeholder to determine whether the combination of fighting alternatives includes any fighting alternatives that are not cumulative, subsets or overrides, and then calculates the aggregated values for satisfaction and harm from the selected combination of fighting alternatives by adding for each stakeholder interest the level of satisfaction and subtracting the level of harm caused by each fighting alternative that affects the issue subject to the data on non-cumulatives, subsets and overrides. When fighting alternatives that are not cumulative on a given issue are either selected for inclusion by the users in a stakeholder's fighting alternative plan or considered by the system for inclusion in a stakeholder's provisional fighting alternative plan, the system selects for the calculation of aggregate effects on stakeholder interests the largest integer (for the level of harm or satisfaction) from among the non-cumulative fighting alternatives.

When a combination of fighting alternatives is selected for inclusion in a stakeholder's fighting alternative plan, the sum of satisfaction or harm values on each stakeholder interest for that stakeholder's fighting alternative plan is therefore the aggregated effects from all cumulative fighting alternatives in the fighting alternative plan that cause satisfaction or harm of the particular stakeholder interest, excluding the satisfaction or harm caused by the smaller fighting alternatives in subsets and by fighting alternatives overridden by other fighting alternatives.

The following describes how the system takes into account incompatible fighting alternatives, non-cumulative fighting alternatives, fighting alternative subsets and fighting alternative overrides when aggregating the effects of fighting alternatives on stakeholder interests:

### Incompatibility

Incompatible fighting alternatives only occur within the fighting alternatives of one stakeholder and do not cross over from one stakeholder to another, so that even though two stakeholders have fighting alternatives that appear incompatible (such as both stakeholders winning a lawsuit against each other), such apparently incompatible fighting alternatives of different stakeholders are not deemed incompatible for purposes of the system. (The system accounts for the apparent incompatibility of different stakeholders' fighting alternatives by having the users discount the likelihood of success of each fighting alternative so that the users should not input more than 100% likelihood of success for any set of incompatible fighting alternatives of different stakeholders.) For any given stakeholder with incompatible fighting alternatives, fighting alternatives that are incompatible cannot be combined at all in a fighting alternative plan or other combination. If the users select incompatible fighting alternatives for a fighting alternative plan, the system will not accept both fighting alternatives, and will notify the users that the fighting alternatives are incompatible. Similarly, the system will not include incompatible fighting alternatives in any stakeholder's provisional fighting alternative plan generated by the system according to the formula set forth below.

### Non-cumulatives

Unlike incompatible fighting alternatives, non-cumulative fighting alternatives are not stakeholder specific. That is, the fighting alternatives of different stakeholders may be non-cumulative with each other. When two or more fighting alternatives are not cumulative with each other, then the most extreme (i.e., highest integer) effect of the non-cumulative fighting alternatives is added to the aggregated effects of the fighting alternative plan on each issue for which the non-cumulative fighting alternatives have an effect. That is, issue-by-issue, among the non-cumulative fighting alternatives, the most extreme effect for that issue is included into the calculation of aggregate fighting alternative plans. If two or more fighting alternatives are designated non-cumulative, and on an issue one of the fighting alternatives has a positive effect and one of the fighting alternatives has a negative effect, then the system will notify the users of this inconsistency so that the users can select one of the fighting alternatives for inclusion in the aggregated effects for that issue or re-designate the fighting alternatives as cumulative so that more than one can be included in the aggregated effects for that issue.

For example, if there are 3 fighting alternatives with the following properties:

Fighting Alternative A=Not cumulative with B, 80% likely to succeed, and Satisfy 5 (out of 10)

Fighting Alternative B=Not cumulative with A, 100% likely to succeed, and Satisfy 5; and

Fighting Alternative C=50% likely to succeed, and Satisfy 2

The following calculation shows how these fighting alternatives would be added together on a given issue if all three were selected for the fighting alternative plan:

A=80%×5=+4 (rounded)

B=100%×5=+5 (rounded)

B is selected because it has the higher value=+5

Plus

C=+1

Equals +6 (total effect of the fighting alternatives on this issue)

### Subsets

Like non-cumulative fighting alternatives, fighting alternative subsets are not stakeholder specific. That is, the fighting alternatives of different stakeholders may be subsets of each other. If Fighting Alternative A is a subset of Fighting Alternative B, and both A and B are selected for inclusion in a fighting alternative plan, then Fighting Alternative B completely overrides Fighting Alternative A, and the only effects included in the fighting alternative plan are the ratings from the effects of Fighting Alternative B. Fighting Alternative A, the subset of Fighting Alternative B in this case, becomes invisible whenever B is included in a fighting alternative plan. (By contrast, if B is not included in a fighting alternative plan, then A's ratings are added to the aggregated effects of the plan.) Subsets are overridden by the fighting alternative of which they are a subset on every issue they affect.

For example, if there are 3 fighting alternatives with the following properties:

Fighting Alternative A−Subset of B, 100% likely to succeed, and Satisfy 5 (out of 10)

Fighting Alternative B=50% likely to succeed, and Satisfy 5; and

Fighting Alternative C=50% likely to succeed, and Satisfy 2

The following calculation shows how these fighting alternatives would be added together on a given issue if all three were selected for the fighting alternative plan:

A=Overridden as a Subset of B

B=50%×5−+3 (rounded)

Plus

C=+1

Equals +4 (total effect of the fighting alternatives on this issue).

### Overrides

Overrides are very similar to subsets mentioned above. Like subsets, fighting alternative overrides are not stakeholder specific. That is, the fighting alternatives of different stakeholders may override each other. There are important differences, however, between overrides and subsets. First, unlike subsets, fighting alternatives that override other fighting alternatives may occur individually or in combination with other overriding fighting alternatives. Second, unlike subsets (which cover all issues they affect), overrides must be identified issue-by-issue; they do not necessarily override other fighting alternatives on every issue they affect. The users must therefore identify the issues on which a given fighting alternative or set of fighting alternatives overrides other fighting alternatives. Third, overrides can override one fighting alternative or multiple fighting alternatives. The users must identify all fighting alternatives that are overridden by other fighting alternatives.

For example, if there are 4 fighting alternatives with the following properties:

Fighting Alternative A=Overrides B, 100% likely to succeed, and Satisfy 5

Fighting Alternative B=Overridden by A, Overrides D when combined with C, 100% likely to succeed, and Satisfy 5;

Fighting Alternative C=Overrides D when combined with B, 50% likely to succeed, and Satisfy 2; and

Fighting Alternative D=Overridden by Combination of B and C, Harm 4.

The following calculation shows how these fighting alternatives would be added together on a given issue if all four were selected for the fighting alternative plan:

A=100%×5=+5

B=Overridden by A

C=50%×2=+1

D=Overridden by combination of B and C

Equals +6 (total effect of the fighting alternatives on this issue)

### Likelihood of Success

Likelihood of success affects the above calculations in two ways:

1) When an overriding fighting alternative is less than 100% likely to succeed:

In this situation, if a fighting alternative that is less than 100% likely to succeed is overriding other fighting alternatives, then the effects of the overriding fighting alternative must be discounted by the likelihood of success of that fighting alternative, and the effects of the other overridden fighting alternatives must be added (after they are discounted by their own likelihood of success) to each other and then discounted by the remaining likelihood that the overriding fighting alternative will not succeed. For example, if there are 3 fighting alternatives with the following properties:

Fighting Alternative A=Overrides B and C, 80% likely to succeed, and Satisfy 6 (out of 10)

Fighting Alternative B=Overridden by A, 100% likely to succeed, and Harm 5; and

Fighting Alternative C=Overridden by A, 50% likely to succeed, and Satisfy 2.

The following calculation shows how the likelihood of success affects the formulas for the effects on interests:

Fighting Alternative A=80%×6=+5 (rounded)

Plus

The sum of Fighting Alternatives B and C=(100%×−5)+(50%×2))×(likelihood A will not succeed)=−4×20%=−1 (rounded)

Equals +4 (total effect of the fighting alternatives on this issue)

2) When a combination of two or more fighting alternatives overrides other fighting alternatives:

In this situation, if a combination of more than one fighting alternative overrides other fighting alternatives (but not where one fighting alternative is a subset of another), then the likelihood of success for each of the fighting alternatives in the overriding combination must be multiplied against each other after the combined effects of the fighting alternatives in the overriding combination have been discounted individually and added to each other. This generates a combined likelihood of success for the combination. If the combined likelihood of success of the fighting alternatives in the overriding combination is less than 100%, then the aggregated effects of the fighting alternatives in the overriding combination must be added to the effects of the other overridden fighting alternatives. First, the aggregated effects of the fighting alternatives in the overriding combination are added together. Then the effects of the other overridden fighting alternatives must be added (after they are discounted by their own likelihood of success) to each other and then discounted by the remaining likelihood that the overriding combination of fighting alternatives will not succeed. For example, if there are 4 fighting alternatives with the following properties:

Fighting Alternative A=Overrides all other fighting alternatives when combined with B, 80% likely to succeed, and Satisfy 8

Fighting Alternative B=Overrides all other fighting alternatives when combined with A, 70% likely to succeed, and Harm 4;

Fighting Alternative C=Overridden by combination of A and B, 50% likely to succeed, and Satisfy 6

Fighting Alternative D=Overridden by combination of A and

B, 20% likely to succeed, and Satisfy 5.

The following calculation shows how the likelihood of success affects the formulas for the effects on interests:

Overriding Combination of A and B=(80%×8)+(70%×−4)=+3 (rounded)

Plus

The sum of C and D=((50%×6)+(20%×5))=+4.

Discounted by likelihood the overriding combination of fighting alternatives will not succeed=Combined likelihood of success of A and B=80%×70%=60% (rounded)=100%−60%=40%×4=+2 (rounded) Equals

+5 (total effect of the fighting alternatives on this issue).

If the users would like to see the aggregated (or individual) effects of any fighting alternative or combination of fighting alternatives undiscounted by the likelihood of success, the system re-calculates the aggregated effects undiscounted and displays them in a graph, chart, list or other format. The undiscounted effects assume that each fighting alternative will be successful. This allows the users to evaluate and communicate to others, such as negotiation counterparts, the possible consequences of fighting alternatives if those fighting alternatives are successfully implemented.

The users may return to any earlier part of the process and repeat that part of the process, and may add, modify, or remove fighting alternatives as the process continues, block 220. The users may also re-evaluate and modify the data regarding the effects of fighting alternatives on stakeholders interests, including the data of incompatibles, non-cumulatives, subsets and overrides.

The system produces a Stakeholder Fighting Alternatives List (SFAL) as a result of the above data entered by the users about possible fighting alternatives, block 225. The objective is to identify all of the fighting alternatives available to each stakeholder and indicate the effects of those fighting alternatives on stakeholder interests so that the users can develop (if applicable) their own fighting alternative plans, and consider the fighting alternatives that other stakeholders may pursue if a negotiated resolution or decision is not reached. The users can use the SFAL to select combinations of possible fighting alternatives that can be compared to the provisional fighting alternative plans identified by the system, according to the formula set forth below.

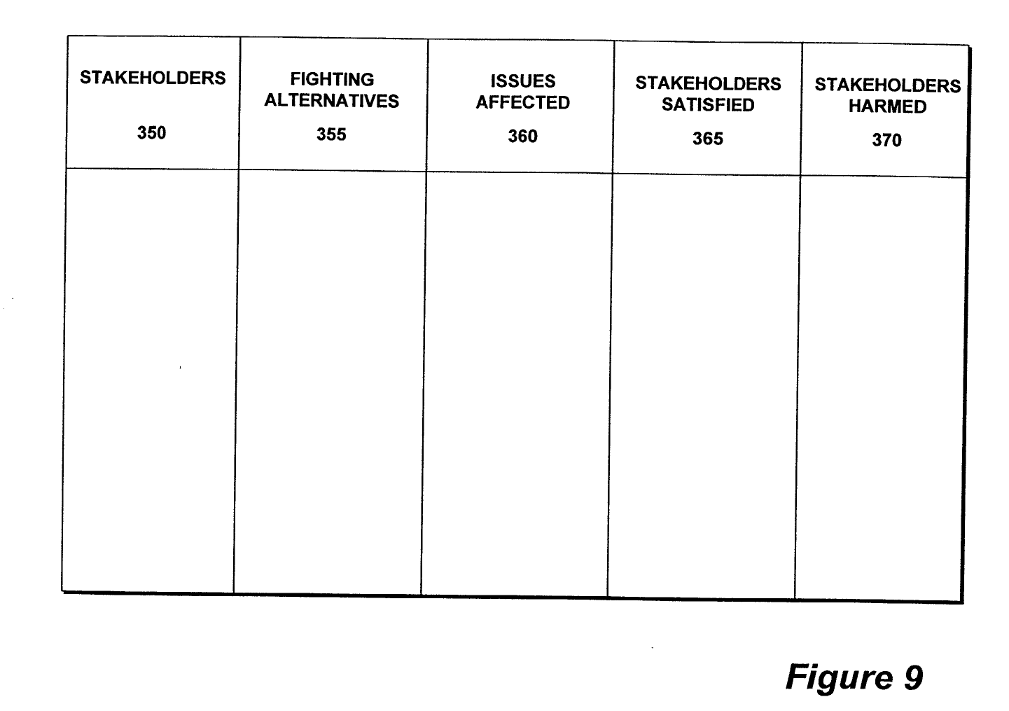

FIG. 9 shows a Stakeholder Fighting Alternatives List. The Stakeholder Fighting Alternatives List has five columns, a Stakeholders column 350, a Fighting Alternatives column 355, an Issues Affected column 360, a Stakeholders Satisfied column 365, and a Stakeholders Harmed column 370. The Stakeholders column 350 is a list of all stakeholders for whom the users have identified any fighting alternatives so that the users can select a stakeholder and the system will then display in the Fighting Alternatives column 355 all of the fighting alternatives developed for the selected stakeholder as described above. The Issues Affected column 360 is a list of all issues affected by any fighting alternative selected by the users from the Fighting Alternatives column 355. The Stakeholders Satisfied column 365 lists all of the stakeholders satisfied by any fighting alternative in the list selected by the users on any affected issue selected by the users. The Stakeholders Harmed column 370 lists all of the stakeholders harmed by a selected fighting alternative from the list on a selected issue from the list. As the users select different stakeholders, different sets of fighting alternatives will appear in the fighting alternatives column to show only those fighting alternatives available to the selected stakeholder. Similarly, as the users select different fighting alternatives, different sets of issues will appear in the issues column to show only those issues affected by the selected fighting alternative. Similarly, as different issues are selected, only those stakeholders satisfied by the selected fighting alternative on the selected issue will appear in the Stakeholders Satisfied column. The same principle applies to the stakeholders appearing in the Stakeholders Harmed column. The order of the columns in the SFAL can be changed by the users so that issues, stakeholders satisfied or stakeholders harmed will appear to the immediate right of the stakeholders column, followed by the fighting alternatives in the middle column.

Based on the aggregate effects of various combinations of fighting alternatives, and subject to the rules imposed by incompatibility, non-cumulatives, subsets and overrides, the system calculates the combination of fighting alternatives for each stakeholder that maximizes aggregate satisfaction of that stakeholder's critical and important interests (and the critical and important interests of its allies) and harms the critical and important interests of other adverse stakeholders who are essential to achieving a negotiated resolution, block 320. This combination becomes a provisional fighting alternative plan for that stakeholder. The users may modify the provisional fighting alternative plan for any stakeholder at any time by adding, removing or modifying fighting alternatives from the fighting alternative plan or by re-evaluating the effects of fighting alternatives on stakeholder interests, block 330. In addition, the users can create different fighting alternative plans for any stakeholder in the fourth phase of the system by selecting combinations of fighting alternatives for that stakeholder.

The criteria used by the system to select fighting alternatives for each stakeholder's provisional fighting alternative plan reflect the likelihood that stakeholders will act in certain patterns given the options available to them. The system evaluates every possible combination of fighting alternatives for each stakeholder-subject to the above rules for combining incompatible fighting alternatives, non-cumulative fighting alternatives, fighting alternative subsets, and fighting alternative overrides-to determine which fighting alternatives should be selected for that stakeholder's provisional fighting alternative plan.

The fighting alternatives are selected by the system for each stakeholder's provisional fighting alternative plan through a series of calculations that apply specific criteria to determine afighting alternative plan for that stakeholder. That is, for each stakeholder the system will perform calculations of various types of “Satisfaction Indices” for all possible combinations of that stakeholder's fighting alternatives, and thereby determine which fighting alternatives the stakeholder should pursue so as to accomplish the following: (1) maximize satisfaction of the stakeholder's interests; (2) maximize satisfaction of the interests of the stakeholder's allies; and (3) maximize harm to the interests of the stakeholder's adversaries who are essential to a negotiated agreement or decision. In making these calculations, the system only considers possible combinations of fighting alternatives that are available to the stakeholder for whom the provisional fighting alternative plan is being determined.

For each combination of fighting alternatives available to the stakeholder for whom the provisional fighting alternative plan is being determined, the system calculates a Stakeholder Fighting Alternative Satisfaction Index (SFASI) score. In order to calculate the various SFASI scores for all of the possible combinations of fighting alternatives, the system will evaluate how a given combination of fighting alternatives affects the interests of certain stakeholders on each issue any of the fighting alternatives in the combination affects. There are three categories of stakeholder interests that will be considered by the system in determining the SFASI scores for each possible combination of fighting alternatives. The three categories of stakeholder interests are (a) the interests of the stakeholder whose fighting alternatives are being evaluated for a provisional fighting alternative plan (“Stakeholder 1”); (b) the interests of all stakeholders who are allies of Stakeholder 1; and (c) the interests of all stakeholders who are adversaries of Stakeholder 1 and are also essential to a negotiated resolution or decision. In determining the SFASI scores for each possible combination of fighting alternatives, the system will only consider those interests that are either critical or important to at least one of the three categories of stakeholder interests. That is, the only qualifying interests that will be taken into account by the system in calculating SFASI scores for a given Stakeholder 1 are the critical interests and important interests of that Stakeholder 1, and the critical interests and important interests of the allies and essential adversaries of Stakeholder 1.

The purpose of evaluating all possible combinations of fighting alternatives for each stakeholder is for the system to identify the combination that yields the highest Total Aggregate SFASI score on all qualifying interests for that stakeholder. In evaluating all possible combinations of fighting alternatives to find the combination that yields the highest Total Aggregate SFASI score on all qualifying interests for a given stakeholder, the system must take into account the above rules for combining incompatible fighting alternatives, non-cumulative fighting alternatives, fighting alternative subsets, and fighting alternative overrides, but the system only applies those rules to the fighting alternatives available to that stakeholder. That is, no combination can include any fighting alternatives that are incompatible for that stakeholder. Nor can the system add to the Total Aggregate SFASI scores for any given combination the effects of fighting alternatives that are subsets of other fighting alternatives included in the combination. Nor can the system add to the SFASI scores on any qualifying interest the effects from any given combination of fighting alternatives that are overridden on that interest by other fighting alternatives included in the combination. Nor can the system add together for the SFASI scores on any qualifying interest the effects of fighting alternatives that are not cumulative on that interest with other fighting alternatives included in the combination. For such non-cumulative fighting alternatives, the system applies the following rule in order to select one of the non-cumulative fighting alternatives from the combination to include in the calculation of the SFASI score on the qualifying interest: the most extreme (i.e., highest integer) effect of the non-cumulative fighting alternatives is added to the aggregated effects of the other, cumulative fighting alternatives that affect the qualifying interest. (If two or more fighting alternatives are designated non-cumulative, and on an issue one of the fighting alternatives has a positive effect and one of the fighting alternatives has a negative effect, then the system will notify the users of this inconsistency so that the users can select one of the fighting alternatives for inclusion in the aggregated effects for that issue or redesignate the fighting alternatives as cumulative so that more than one can be included in the aggregated effects for that issue.)

The system applies the following formula to calculate the Total Aggregate SFASI scores for each possible combination of fighting alternatives for each stakeholder:

To determine the Critical Interest SFASI score for each combination of fighting alternatives (subject to the above rules on incompatibility, subsets, overrides and non-cumulatives), the system:

Identifies on each issue in which Stakeholder 1 has a critical interest the level of satisfaction or harm (if any) that each fighting alternative in the combination brings Stakeholder 1, and for each such fighting alternative, multiplies the integer representing the satisfaction or harm caused by that fighting alternative on that critical interest by the percentage likelihood of success for that fighting alternative. After discounting the integers by the likelihood of success, the system then adds together all integers representing such satisfaction and subtracts all integers representing such harm. This calculation of aggregate satisfaction or harm yields a Subtotal A1. (Note: Subtotal A1 may be a positive or negative integer.)

Multiplies Subtotal A1 by 100. This calculation yields a Subtotal B1. (Note: Subtotal B1 may be a positive or negative integer.)

Identifies on each issue in which any ally of Stakeholder 1 has a critical interest the level of satisfaction or harm (if any) that each fighting alternative in the combination brings that ally of Stakeholder 1, and for each such fighting alternative, multiplies the integer representing the satisfaction or harm caused by that fighting alternative on that critical interest by the percentage likelihood of success for that fighting alternative. After discounting the integers by the likelihood of success, the system then adds together all integers representing such satisfaction and subtracts all integers representing such harm. This calculation of aggregate satisfaction or harm yields a Subtotal C1. (Note: Subtotal C1 may be a positive or negative integer.)

Multiplies Subtotal C1 by 40. This calculation yields a Subtotal D1. (Note: Subtotal D1 may be a positive or negative integer.)

Identifies on each issue in which any essential adversary of Stakeholder 1 has a critical interest the level of satisfaction or harm (if any) that each fighting alternative in the combination brings that essential adversary of Stakeholder 1, and for each such fighting alternative, multiplies the integer representing the satisfaction or harm caused by that fighting alternative on that critical interest by the percentage likelihood of success for that fighting alternative. After discounting the integers by the likelihood of success, the system then adds together all integers representing such harm and subtracts all integers representing such satisfaction. This calculation of aggregate harm or satisfaction yields a Subtotal E1. (Note: Subtotal E1 may be a positive or negative integer.)

Multiplies Subtotal E1 by 45. This calculation yields a Subtotal F1. (Note: Subtotal F1 may be a positive or negative integer.)

Adds Subtotals B1, D1 and F1. This calculation yields a Subtotal G1, which is the Critical Interest SFASI score for that combination of fighting alternatives on each qualifying interest. (Note: Subtotal G1 may be a positive or negative integer.)

To determine the Important Interest SFASI score for each combination of fighting alternatives (subject to the above rules on incompatibility, subsets, overrides and non-cumulatives), the system:

Identifies on each issue in which Stakeholder 1 has an important interest the level of satisfaction or harm (if any) that each fighting alternative in the combination brings Stakeholder 1, and for each such fighting alternative, multiplies the integer representing the satisfaction or harm caused by that fighting alternative on that important interest by the percentage likelihood of success for that fighting alternative. After discounting the integers by the likelihood of success, the system then adds together all integers representing such satisfaction and subtracts all integers representing such harm. This calculation of aggregate satisfaction or harm yields a Subtotal A2. (Note: Subtotal A2 may be a positive or negative integer.)

Multiplies Subtotal A2 by 60. This calculation yields a Subtotal B2. (Note: Subtotal B2 may be a positive or negative integer.)

Identifies on each issue in which any ally of Stakeholder 1 has an important interest the level of satisfaction or harm (if any) that each fighting alternative in the combination brings that ally of Stakeholder 1, and for each such fighting alternative, multiplies the integer representing the satisfaction or harm caused by that fighting alternative on that important interest by the percentage likelihood of success for that fighting alternative. After discounting the integers by the likelihood of success, the system then adds together all integers representing such satisfaction and subtracts all integers representing such harm. This calculation of aggregate satisfaction or harm yields a Subtotal C2. (Note: Subtotal C2 may be a positive or negative integer.)

Multiplies Subtotal C2 by 25. This calculation yields a Subtotal D2. (Note: Subtotal D2 may be a positive or negative integer.)

Identifies on each issue in which any essential adversary of Stakeholder 1 has an important interest the level of satisfaction or harm (if any) that each fighting alternative in the combination brings that essential adversary of Stakeholder 1, and for each such fighting alternative, multiplies the integer representing the satisfaction or harm caused by that fighting alternative on that important interest by the percentage likelihood of success for that fighting alternative. After discounting the integers by the likelihood of success, the system then adds together all integers representing such harm and subtracts all integers representing such satisfaction. This calculation of aggregate harm or satisfaction yields a Subtotal E2. (Note: Subtotal E2 may be a positive or negative integer.)

Multiplies Subtotal E2 by 20. This calculation yields a Subtotal F2. (Note: Subtotal F2 may be a positive or negative integer.)

Adds Subtotals B2, D2 and F2. This calculation yields a Subtotal G2, which is the Important Interest SFASI score for that combination of fighting alternatives on each qualifying interest. (Note: Subtotal G2 may be a positive or negative integer.)

To determine the Total Aggregate SFASI score for each combination of fighting alternatives, the system:

Adds together the Critical Interest SFASI scores (Subtotal G1) for all qualifying interests affected by that combination of fighting alternatives. This calculation yields a Subtotal A3, the Aggregated Critical Interest SFASI score for that combination of fighting alternatives. (Note: Subtotal A3 may be a positive or negative integer.)

Adds together the Important Interest SFASI scores (Subtotal G1) for all qualifying interests affected by that combination of fighting alternatives. This calculation yields a Subtotal B3, the Aggregated Important Interest SFASI score for that combination of fighting alternatives. (Note: Subtotal B3 may be a positive or negative integer.)

Adds together the Aggregated Critical Interest SFASI scores (Subtotal A3) and the Aggregated Important Interest SFASI scores (Subtotal B3). This calculation yields a Subtotal C3, the Total Aggregate SFASI score for that combination of fighting alternatives. (Note: Subtotal C3 may be a positive or negative integer.)

The system then compares the Total Aggregate SFASI score (Subtotal C3) for each possible combination of fighting alternatives so as to determine which combination will produce the highest (positive) Total Aggregate SFASI score. The system selects the combination of fighting alternatives with the highest Total Aggregate SFASI score to be the Provisional Fighting Alternative Plan for that stakeholder. (Note: If no possible combination of fighting alternatives yields a Total Aggregated SFASI score higher than 0 for a given stakeholder, then the system alerts the users that that stakeholder has no likely provisional fighting alternative plan.)

After the system has determined the provisional fighting alternative plan for Stakeholder 1, the system then performs the above set of calculations to determine the provisional fighting alternative plans for each other stakeholder.

In alternative embodiments of the invention, different formulas can be used to select fighting alternatives for provisional fighting alternative plans.

Finally, the effects of the provisional fighting alternative plans on stakeholder interests are displayed in response to user input through a variety of graphic illustrations, including color-coding the effects of individual stakeholder provisional fighting alternative plans or the aggregated effects of some or all provisional fighting alternative plans on the interest chart, block 325, and in bar graphs. The users select display criteria, such as stakeholders, issues and types of interests to display. At the users' discretion, the data of effects on stakeholder interests caused by fighting alternatives and fighting alternative plans can be displayed discounted by the percentage likelihood of success for the fighting alternatives included, or undiscounted by the likelihood of success.

The information derived in this phase is recorded in a database for the fighting alternatives and the provisional fighting alternative plan for each stakeholder involved in or affected by the planning session or negotiation.

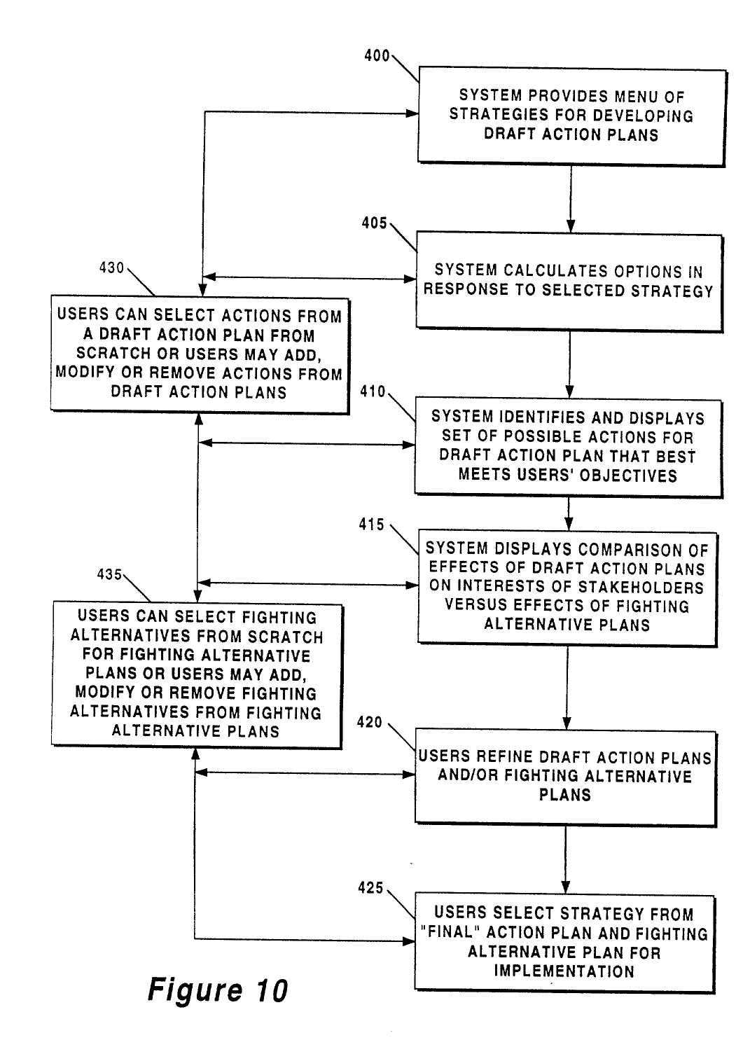

FIG. 10 is a flow chart showing the method of the fourth phase of the operation of the system of the present invention. In this phase, the users can analyze a variety of possible actions from the PAL that can form the basis of action plans for a strategic plan or a negotiated agreement.

In addition, the users can analyze a variety of possible fighting alternatives from the SFAL that can form the basis of fighting alternative plans that are different from the provisional fighting alternative plans selected by the system according to the formula set forth above.

In deciding which possible actions to include in the action plans, the users can select from a menu of negotiation strategies for identifying sets of actions that yield varying levels of satisfaction or harm to the interests of stakeholders chosen by the users. The users compare a) the level of satisfaction and harm that selected combinations of actions will bring to the interests of the stakeholders, against b) the level of satisfaction and harm that the fighting alternatives identified in the fighting alternative plans will bring in order to determine whether each stakeholder will be better off agreeing to the negotiated agreement of a specified action plan or pursuing their independent fighting alternatives. If any stakeholder would be better off pursuing its fighting alternative plan, then the users may consider whether a specified action plan can be improved from the perspective of that stakeholder so as to make a negotiated agreement more attractive for that stakeholder. The users may save and store various sets of possible actions as action plans for later reference and use.

Referring again to FIG. 10, the first step in forming an action plan is for the users to select from a menu of strategies for identifying sets of actions that yield varying levels of satisfaction or harm to the interests of specified stakeholders chosen by the users, block 400. The menu offers a list of seven distinct strategies from which the users can select. The strategies encompass different methods of identifying actions that will bring varying levels of satisfaction and harm to specified stakeholder interests chosen by the users. The users select the strategy that is most likely to identify combinations of actions that bring about the levels of satisfaction or harm desired by the users for stakeholder interests specified by the users. The strategies are calibrated by the users to meet objectives defined by the users, such as, for example, a) equalization of satisfaction of specified interests among various selected stakeholders or b) maximization of satisfaction of specified interests for one or more selected stakeholders or (c) setting a floor of minimum levels of satisfaction of interests among selected stakeholders. The users consider various options by selecting from the menu of strategies and instruct the system how to organize these options to facilitate evaluation of the options. The system then calculates options based on the criteria identified through the users' selections from the menu of strategies and the data provided by the users in earlier phases, and evaluates all possible combinations of actions from the PAL so as to identify the combinations of actions that will most effectively meet the users' objectives for satisfying (or harming) specified interests of selected stakeholders to levels of satisfaction (or harm) chosen by the users, block 405. For example, the users may select a strategy that identifies a set of possible actions for maximizing the aggregate satisfaction of the users' critical and important interests as long as the set of possible actions also brings a minimum level of satisfaction to the critical interests of other essential stakeholders that is equal to or greater than the satisfaction the other essential stakeholders would receive from pursuing their fighting alternative plans. The system will then calculate and display the set of possible actions that most effectively meets the users' defined objectives, block 410. In addition, the users are able to design their own strategies from scratch and select any combination of actions they prefer for a draft action plan.

The users can select from any of the following seven strategies for identifying possible actions to be included in an action plan. The users can select any of the strategies at any time once the actions have been entered into the system, and (if applicable) once the provisional fighting alternative plans have been determined. The seven strategies are:

1) Select “Win-Win” Actions;

2) Set Floor of Satisfaction for Essential Stakeholders;

3) Set Floor of Satisfaction for One Stakeholder;

4) Customize Minimum Levels of Satisfaction for Stakeholders;

5) Equalize Satisfaction of Specified Stakeholders;

6) Maximize Satisfaction of Selected Stakeholders; and

7) The Users Select Actions from Scratch.

The system provides the seven strategies for selecting actions to be included in an action plan (subject to the above rules on incompatible actions, action subsets, action overrides, and non-cumulative actions) as follows:

### Strategy 1

### Select “Win-Win” Actions

This strategy is designed to identify for the users all “win-win” actions that will satisfy—and will not harm—the critical and important interests of the stakeholders who are essential to a negotiated resolution or decision. After the “win-win” actions have been identified by the system, the users can consider expanding the selection of actions.

### First Step

The system considers only the effects of possible actions on the important and critical interests of essential stakeholders. The system excludes all actions that harm any important or critical interest of any essential stakeholder.

If two or more incompatible actions meet the above criterion, then the system selects the action that has the highest aggregate satisfaction level on all important and critical interests of every essential stakeholder, and the other incompatible actions are eliminated from this selection of Win-Win actions.

### Second Step

The system displays all possible actions that meet the above criteria and all possible actions (if any) that would have met the above criteria, except that they harmed one important interest of one essential stakeholder (but did not harm any critical interests of any essential stakeholders). The system provides the users display formats, including bar graphs, interest charts and lists, so that the users can see data of the effects of these possible actions on the critical and important interests of essential stakeholders and the users can decide whether to add any of the excluded actions to the action plan.

### Third Step

The system displays a bar graph with data of the aggregated effects of all of the actions included in the action plan to illustrate each important or critical interest of any essential stakeholder (if any) that has not been fully satisfied (up to 10 on a scale of 10). The system provides a Possible Actions List (PAL) with all possible actions that could satisfy any of the interests displayed on the graph. The users can add any of those actions to the action plan.

### Fourth Step

The system provides a complete Possible Actions List (PAL) that indicates each action included in the action plan and each action not included, as well as the issues affected by the actions and the stakeholders satisfied and harmed by the actions. While the PAL is displayed, the system also provides the users the ability simultaneously to use a re-sizable window to view on an interest chart or bar graphs (with display criteria selected by the users) the effects of the action plan or any individual action or fighting alternative, or combination of actions or fighting alternatives, including fighting alternative plans. The users can then modify the action plan by adding actions, removing actions, developing new actions to be considered for the action plan, or modifying existing actions. The users can save the action plan and/or create entirely new action plans.

### Strategy 2

### Set Floor of Satisfaction for Essential Stakeholders

This strategy is designed to allow the users to select minimum levels of satisfaction on critical and important interests for all essential stakeholders. Then the users can select one or more stakeholders, including the users themselves, to have their critical and important interests satisfied as much as possible without reducing the satisfaction of the other essential stakeholders below the minimum levels selected by the users.

### First Step

The system allows the users to set a minimum level of satisfaction required for each important and critical interest of each essential stakeholder. There are a number of choices the system provides for the users in setting the minimum level of satisfaction for the essential stakeholders. Each set of choices is listed below:

The users can set (a) a customized minimum level of satisfaction for each essential stakeholder; or (b) the same minimum level of satisfaction for all essential stakeholders; or (c) a customized minimum level of satisfaction for some essential stakeholders and the same minimum level of satisfaction for all other essential stakeholders.

The users can set (a) a minimum level of satisfaction on each critical and important interest; or (b) the same minimum level of satisfaction on all critical and important interests; or (c) a minimum level of satisfaction for all important interests and a separate minimum level of satisfaction for all critical interests; or (d) a minimum level of satisfaction on each critical interest and a separate minimum level of satisfaction that is the same for all important interests; or (e) a minimum aggregate level of satisfaction for each stakeholder on all important and critical interests; or (f) a minimum level of satisfaction for each critical interest and an aggregate minimum level of satisfaction for all important interests; or (g) a minimum level of satisfaction for specified critical or important interests and an aggregate minimum level of satisfaction for all other critical and important interests.

The users can set a minimum level of satisfaction for each stakeholder or stakeholders (a) relative to the level of satisfaction the stakeholder or stakeholders would receive from the aggregated stakeholder fighting alternative plans; or (b) without regard to the fighting alternative plans of the stakeholders.

If the users choose to set the minimum level of satisfaction relative to satisfaction from the aggregated stakeholder fighting alternative plans, then the following five strategies will be available:

Hard Line (10% less satisfaction than the stakeholder receives if the stakeholders pursue fighting alternative plans);

Fighting Alternative Plans (the same level of satisfaction as the stakeholder receives if the stakeholders pursue fighting alternative plans);

Aggressive (10% more satisfaction than the stakeholder receives if the stakeholders pursue fighting alternative plans);

Reasonable (25% more satisfaction than the stakeholder receives if the stakeholders pursue fighting alternative plans);

Generous (50% more satisfaction than the stakeholder receives if the stakeholders pursue fighting alternative plans);

The system advises the users that the parameters defined by the users' selections from the above choices may greatly restrict the combinations of possible actions considered by the system for the action plan. That is, the more restrictive the criteria selected by the users, the fewer the likely combinations of actions available to the system to meet the criteria.

### Second Step

After minimum levels of satisfaction for essential stakeholders have been set in step 1 above, the users must select one or more stakeholders whose important and critical interests the users would like satisfied as much as possible once a minimum level of satisfaction has been achieved for each critical or important interest of each essential stakeholder. (The users may be one of the stakeholders selected.)

### Third Step

If more than one stakeholder is selected in step 2 above, then the users may choose from one of two options in maximizing satisfaction of the critical and important interests of the identified stakeholders. The choices are for the system to select actions either (a) to maximize the aggregate satisfaction of the critical and important interests of the identified stakeholders, or (b) to equalize the aggregate satisfaction of the critical and important interests of the identified stakeholders within parameters chosen by the users.

If the users choose to have the system equalize satisfaction, then the users must identify those stakeholders in the group the users want to equalize and the following choices are available for those stakeholders:

Equalize aggregate satisfaction on all critical and important interests;

Equalize aggregate satisfaction on all critical interests;

Equalize satisfaction on each critical interest; or

Equalize satisfaction on each critical and important interest.

In addition, the system provides the users the following choices:

Equalize satisfaction relative to the satisfaction the stakeholders would receive if fighting alternative plans were pursued; and

Equalize satisfaction relative to the satisfaction the other stakeholders in the group will receive from the action plan (without regard to fighting alternatives).

Finally, the system allows the users to choose from the following range of equality for all of the stakeholders selected for equal satisfaction:

Plus or minus 5 percent (from the highest aggregate satisfaction among the stakeholders to the lowest);

Plus or minus 10 percent;

Plus or minus 25 percent; or

Plus or minus 50 percent.

The system advises the users that the parameters defined by the users' selections from the above choices may greatly restrict the combinations of possible actions considered by the system for the action plan.

### Fourth Step

After the minimum levels of satisfaction have been set by the users in step 1 above for each qualifying interest, and the stakeholder or stakeholders and satisfaction criteria for maximization have been selected in steps 2 and 3 above, the system evaluates every possible combination of actions (subject to the above rules on incompatible actions, action subsets, action overrides, and non-cumulative actions) to identify the combination of actions, if any, that achieves the required minimum satisfaction levels for the specified stakeholder interests, and then maximizes (subject, if applicable, to the equalization criteria set by the users) satisfaction of the critical and important interests of the selected stakeholder or stakeholders from the second step above to the extent possible without reducing the satisfaction of the essential stakeholders below the required levels. The system evaluates all possible combinations of actions by calculating the aggregate effects of the actions in each possible combination on the qualifying interests. The system then compares the results of these calculations for each combination to identify for the users the combination that most effectively meets the criteria set by the users. If the required minimum levels of satisfaction cannot be achieved, the system identifies the combination of actions that comes closest to meeting the required satisfaction and then maximizes satisfaction to the extent possible of the critical and important interests of the selected stakeholder or stakeholders. The system then displays in a PAL the combination of actions so identified as a possible action plan that can be saved, discarded or modified.

### Fifth Step

After the system has completed the calculations in the fourth step above, the users can have the system select for the action plan additional actions (if any) that increase satisfaction of any critical or important interests of the essential stakeholders without (a) diminishing the satisfaction of important or critical interests of the stakeholder or stakeholders selected by the users in step 2 above, (b) if applicable, violating the equalization criteria from step 3 above, or (c) diminishing the satisfaction of important or critical interests of the other essential stakeholders.

### Sixth Step

The system displays a bar graph with data of the aggregated effects of all of the actions included in the action plan to illustrate each important or critical interest of any essential stakeholder (if any) that has not been satisfied to a level higher than the level of satisfaction that that stakeholder would receive on that interest if the stakeholders pursued their fighting alternative plans. (This is a comparison of the satisfaction, or harm, the action plan will bring on each critical and important interest of each essential stakeholder against the level of satisfaction, or harm, the aggregated fighting alternative plans will bring on those same interests; for any qualifying interests on which the aggregated fighting alternative plans bring greater satisfaction than the action plan, the comparison is displayed on the bar graph showing the effects of the action plan and aggregated fighting alternative plans on that interest.) The system also provides a Possible Actions List (PAL) with all possible actions that could satisfy any of the interests displayed on the graph. The users can add any of those actions to the action plan.

### Seventh Step

This is the same as the fourth step in strategy 1 above.

### Strategy 3

### Set Floor of Satisfaction for One Stakeholder

This strategy is designed to allow the users to select actions that meet minimum levels of satisfaction on selected interests of one stakeholder, such as a user. The system identifies combinations of possible actions that meet the required levels of satisfaction for the qualifying interests and then selects the combination that best satisfies the aggregate critical and important interests of a stakeholder or group of stakeholders selected by the users without reducing the satisfaction of the selected stakeholder below the required level on qualifying interests. The group of stakeholders selected for maximum satisfaction could be, for example, the essential stakeholders (including, if applicable, the stakeholder selected above by the users).

### First Step

The users must select one stakeholder (could be a user) whose important and critical interests the users would like satisfied to a minimum, specified level.

### Second Step

The system allows the users to choose those interests of the stakeholder identified in step 1 for which a minimum level of satisfaction will be set. The users can select (a) all of the important and critical interests of that stakeholder; (b) all of the critical interests of that stakeholder; or (c) any one or combination of important and critical interests of that stakeholder. Once the interests have been selected, there are a number of choices the system provides for the users in setting the minimum level of satisfaction for the interests. Each set of choices is listed below:

The users can set (a) a minimum level of satisfaction on each selected interest; or (b) the same minimum level of satisfaction on all selected interests; or (c) a minimum level of satisfaction for all important selected interests and a separate minimum level of satisfaction for all critical selected interests; or (d) a minimum level of satisfaction on each selected critical interest and a separate minimum level of satisfaction that is the same for all important selected interests; or (e) a minimum aggregate level of satisfaction on all selected interests; or (f) a minimum level of satisfaction for each critical selected interest and an aggregate minimum level of satisfaction for all important selected interests; or (g) a minimum level of satisfaction for certain selected interests and an aggregate minimum level of satisfaction for all other selected interests. (If no important interests are selected, then the above options that relate to important interests are unavailable, and the same applies for critical interests.)

The users can set a minimum level of satisfaction (a) relative to the level of satisfaction the selected stakeholder would receive from the aggregated stakeholder fighting alternative plans; or (b) without regard to the fighting alternative plans of the stakeholders.

If the users choose to set the minimum level of satisfaction relative to satisfaction from the fighting alternative plans, then the same five strategies noted in the first step of strategy 2 above will be available (Hard Line; Fighting Alternative Plans; Aggressive, Reasonable; and Generous).

The system advises the users that the parameters defined by the users' selections from the above choices may greatly restrict the combinations of possible actions considered by the system for the action plan.

### Third Step

After minimum levels of satisfaction for the stakeholder identified in step 1 above have been set in step 2 above, the users must select one or more stakeholders whose important and critical interests the users would like satisfied as much as possible once the specified minimum level of satisfaction has been achieved for the stakeholder identified in step 1 above. (The stakeholder identified in step 1 above may also be one of the stakeholders selected for maximization in this step.)

### Fourth Step

If there is more than one stakeholder selected in step 3 above, then the system provides the users a choice of two options for maximizing satisfaction of the critical and important interests of the selected stakeholders. Either the system will select actions (a) to maximize the aggregate satisfaction of the critical and important interests of the selected stakeholders or (b) to equalize the satisfaction of the critical and important interests of the selected stakeholders within parameters chosen by the users.

If the users opt to equalize satisfaction, then the users must identify those stakeholders in the group the users want to equalize and the system provides the same set of choices for equalization as are available in the third step of strategy 2 above. As in the third step of strategy 2, the system advises the users that the parameters defined by the users' selections may greatly restrict the combinations of possible actions considered by the system for the action plan.

### Fifth Step

After the minimum levels of satisfaction have been set by the users in steps 1 and 2 above for the specified stakeholder and interests, and the stakeholder or stakeholders and satisfaction criteria for maximization have been selected in steps 3 and 4 above, the system evaluates every possible combination of actions (subject to the above rules on incompatible actions, action subsets, action overrides, and non-cumulative actions) to identify the combination of actions, if any, that achieves the required satisfaction levels for the specified stakeholder interests, and then maximizes (subject, if applicable, to the equalization criteria set by the users) satisfaction of the critical and important interests of the stakeholder or stakeholders identified in step 3 above to the extent possible without reducing the satisfaction of the stakeholder selected in step 1 beneath the required levels. The system evaluates all possible combinations of actions by calculating the aggregate effects of the actions in each possible combination on the qualifying interests. The system then compares the results of these calculations for each combination to identify for the users the combination that most effectively meets the criteria set by the users. If the required minimum levels of satisfaction for the stakeholder selected in step 1 cannot be achieved, then the system identifies the combination of actions that comes closest to meeting the required satisfaction and then maximizes satisfaction to the extent possible of the critical and important interests of the stakeholder or stakeholders identified in step 3. The system then displays in a PAL the combination of actions so identified as a possible action plan that can be saved, discarded or modified. Sixth Step 246 After the system has completed the calculations in the fifth step above, the users can have the system select for the action plan additional actions (if any) that increase satisfaction of any critical or important interests of the essential stakeholders without (a) diminishing the satisfaction of important or critical interests of the stakeholder selected by the users in step 1, (b) diminishing the satisfaction of the stakeholders and interests identified in steps 3 and 4 above, (c) if applicable, violating the equalization criteria from step 4 above, or (d) diminishing the satisfaction of important or critical interests of the other essential stakeholders.

### Seventh Step

This is the same as the sixth step in strategy 2 above.

### Eighth Step

This is the same as the fourth step in strategy 1 above.

### Strategy 4

### Customize Minimum Levels of Satisfaction for Stakeholders

This strategy is designed to allow the users to select minimum levels of satisfaction on critical and important interests identified by the users for stakeholders selected by the users. Then the users can select one or more stakeholders (including users) to have their critical and important interests satisfied as much as possible without reducing the satisfaction of the previously selected stakeholders below the minimum levels required by the users.

### First Step

The users must first select one or more stakeholders (could include a user) whose important and critical interests the users would like satisfied to minimum, specified levels.

### Second Step

This step follows the exact process of the first step in strategy 2 above, except that in place of “essential stakeholders” (in strategy 2) this step uses the stakeholder or stakeholders selected by the users in step 1 above.

### Third Step

This step follows the exact process of the second step in strategy 2 above, except that in place of “essential stakeholders” (in strategy 2) this step uses the stakeholder or stakeholders selected by the users in step 1 above.

### Fourth Step

This step follows the exact process of the third step in strategy 2 above.

### Fifth Step

This step follows the exact process of the fourth step in strategy 2 above.

### Sixth Step

This step follows the exact process of the fifth step in strategy 2 above, except that in place of “essential stakeholders” (in strategy 2) this step uses the stakeholder or stakeholders selected by the users in step 1 above.

### Seventh Step

This is the same as the sixth step in strategy 2 above.

### Eighth Step

This is the same as the fourth step in strategy 1 above.

### Strategy 5

### Equalize Satisfaction of Specified Stakeholders

This strategy is designed to allow the users to select actions that equalize the satisfaction of stakeholders specified by the users on interests specified by the users.

### First Step

The users must identify two or more stakeholders for equalized satisfaction of their critical and/or important interests. Subject to criteria for equalization of satisfaction selected by the users in the following steps, the system will identify actions that maximize the aggregate satisfaction of the critical and important interests of the stakeholders for whom the users have indicated equalization.

### Second Step

The system provides the following choices for the users to select a method of equalizing interests of the stakeholders identified for equalization in step 1 above:

Equalize aggregate satisfaction on all critical and important interests;

Equalize aggregate satisfaction on all critical interests;

Equalize satisfaction on each critical interest; or

Equalize satisfaction on each critical and important interest.

In addition, the system provides the users the following choices:

Equalize satisfaction relative to the satisfaction the stakeholders would receive if fighting alternative plans were pursued; and

Equalize satisfaction relative to the satisfaction the other stakeholders in the group will receive from the action plan (without regard to fighting alternatives).

Finally, the system allows the users to choose from the following range of equality for all of the stakeholders selected for equal satisfaction:

Plus or minus 5 percent (from the highest aggregate satisfaction among the stakeholders to the lowest);

Plus or minus 10 percent;

Plus or minus 25 percent; or

Plus or minus 50 percent.

The system advises the users that the parameters defined by the users' selections from the above choices may greatly restrict the combinations of possible actions considered by the system for the action plan.

### Third Step

After the stakeholders and criteria for equalization have been selected in steps 1 and 2 above, the system evaluates every possible combination of actions (subject to the above rules on incompatible actions, action subsets, action overrides, and non-cumulative actions) to identify the combination of actions, if any, that maximizes satisfaction of the critical and important interests of the stakeholders identified in step 1 above—subject to the equalization criteria set by the users. The system evaluates all possible combinations of actions by calculating the aggregate effects of the actions in each possible combination on the qualifying interests. The system then compares the results of these calculations for each combination to identify for the users the combination that most effectively meets the criteria set by the users. If the criteria for equalization of satisfaction of the stakeholders selected in step 1 cannot be met, then the system identifies the combination of actions that comes closest to meeting the criteria for equalization. The system then displays in a PAL the combination of actions so identified as a possible action plan that can be saved, discarded or modified.

### Fourth Step

After the system has completed the calculations in the third step above, the users can have the system select for the action plan additional actions (if any) that increase satisfaction of any critical or important interests of the essential stakeholders without (a) diminishing the satisfaction of important or critical interests of the stakeholders selected by the users in step 1, (b) violating the equalization criteria from step 2 above, or (c) diminishing the satisfaction of important or critical interests of the other essential stakeholders.

### Fifth Step

This is the same as the sixth step in strategy 2 above.

### Sixth Step

This is the same as the fourth step in strategy 1 above.

### Strategy 6

### Maximize Satisfaction of Selected Stakeholders

This strategy is designed to allow the users to select actions that maximize the aggregate satisfaction of a stakeholder (or stakeholders) specified by the users on interests specified by the users.

### First Step

The users must identify one or more stakeholders for maximized satisfaction of their critical and/or important interests. The system will identify actions that maximize the aggregate satisfaction of selected critical and important interests of the selected stakeholder or stakeholders.

### Second Step

The system provides a menu of all critical and important interests of the stakeholder or stakeholders chosen in step 1 above so that the users can select the interests for the system to consider in identifying actions that maximize the aggregate satisfaction of the selected stakeholder or stakeholders on those selected interests.

### Third Step

After the stakeholder or stakeholders and satisfaction criteria for maximization have been selected in steps 1 and 2 above, the system evaluates every possible combination of actions (subject to the above rules on incompatible actions, action subsets, action overrides, and non-cumulative actions) to identify the combination of actions that maximizes the aggregate satisfaction of the selected interests from step 2 above of the selected stakeholder or stakeholders from step 1 above. The system evaluates all possible combinations of actions by calculating the aggregate effects of the actions in each possible combination on the qualifying interests. The system then compares the results of these calculations for each combination to identify for the users the combination that maximizes aggregate satisfaction of the selected interests from step 2 above of the selected stakeholder or stakeholders from step 1 above. The system then displays in a PAL the combination of actions so identified as a possible action plan that can be saved, discarded or modified.

### Fourth Step

After the system has completed the calculations in the third step above, the users can have the system select for the action plan additional actions (if any) that increase satisfaction of any critical or important interests of the essential stakeholders without (a) diminishing the satisfaction of important or critical interests of the stakeholder or stakeholders selected by the users in step 2 above, or (b) diminishing the satisfaction of important or critical interests of the other essential stakeholders.

### Fifth Step

This is the same as the sixth step in strategy 2 above.

### Sixth Step

This is the same as the fourth step in strategy 1 above.

### Strategy 7

### The Users Select Actions from Scratch

The system allows the users to select from scratch whatever actions the users would like for the action plan. The system provides the PAL, interest chart and bar graphs to assist the users in evaluating various possible combinations of actions. The users can use these tools to view the effects of any actions and combinations of actions on the interests of the stakeholders. In addition, the users can try on an ongoing basis any of the above strategies for selecting actions to create various action plans.

In alternative embodiments of the invention, different strategies may be provided. Similarly, in alternative embodiments of the invention, different formulas for selecting actions may be used. Further, in alternative embodiments of the invention, different display formats can be provided to show data, and the displays can occur in a different order and show different data relating to the development of action plans.

After the system has identified possible actions to be included in an action plan according to the criteria specified by the users in selecting the strategy, the users can modify the proposed action plan at any time by adding actions, removing actions, developing new actions to be considered for the action plan, or modifying existing actions. In addition, the system displays data of the aggregate effects of the action plans on stakeholder interests in response to user input so that the users can compare such effects with the effects of fighting alternative plans, individual actions or combinations of actions, individual fighting alternatives or combinations of fighting alternatives, and other action plans. The users select criteria for displaying data, as well as the display formats. The users can select the stakeholders, issues and types of interests to be displayed. The users can have the system display the data on interest charts, bar graphs, or lists. The users can also select the action plans, fighting alternative plans, actions and/or fighting alternatives to include in the data displayed.

The above process develops draft action plans identifying the sets of actions that most effectively meet the users' defined objectives. Once the set of possible actions that most effectively meets the criteria set by the users in a particular strategy has been calculated by the system and displayed, the users are able to evaluate how effectively that set of actions will satisfy or harm the interests of various stakeholders. As noted in each of the above strategies, the users are able to add, remove or modify any actions in the draft action plans so as to refine and improve the draft action plans, block 430.

Then, the system is used to determine how effectively the actions in the draft action plans will satisfy the critical and important interests of key stakeholders, including the users themselves. For example, the system is used to determine whether the interests of key stakeholders will be satisfied more effectively by the aggregate effects of a draft action plan than those stakeholder interests would be satisfied by the stakeholders pursuing their fighting alternative plans, block 415. The following information is assessed:

On each issue, do the draft action plans or the fighting alternative plans better satisfy the users' critical and important interests?

For each other stakeholder who is essential to a decision or a negotiated agreement, do the draft action plans or the fighting alternative plans better satisfy that stakeholder's critical and important interests?

The system depicts the above information in interest charts and bar graphs that display the effects of specified action plans and fighting alternative plans on stakeholder interests. The system allows the users to manipulate the formats of the interest charts and bar graphs to show the effects of any combination of the following on stakeholder interests specified by the users: draft action plans, individual actions or sets of possible actions, fighting alternative plans, and individual fighting alternatives or sets of fighting alternatives. These interest charts and bar graphs visually depict data revealing the effects of various possible courses of action on stakeholder interests and enable the users to evaluate trade-offs, consider how to improve negotiation strategies and fighting alternatives, and decide whether to pursue specific action plans or fighting alternative plans.

The users may develop their own fighting alternative plans or they may select from stored fighting alternative plans. Also, the users may add, modify, or remove fighting alternatives from fighting alternative plans at any point in the process, block 435.

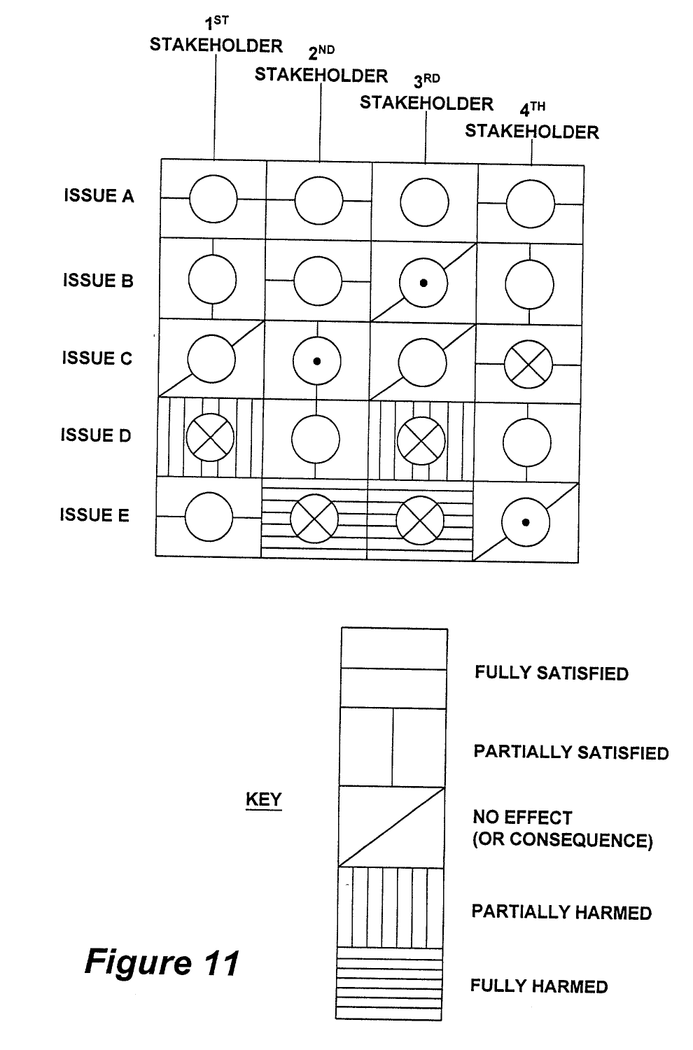

FIG. 11 shows the interest chart of FIG. 4 after the development of an action plan. The effects of the actions on each interest are shown with respect to each stakeholder on each issue. The effects follow the key shown in the figure.

An action may have no effect on an interest, may have some positive effect of partially satisfying an interest, or may satisfy the stakeholder's interest completely.

Alternatively, the action may be somewhat harmful or fully harmful to a stakeholder's interest on a given issue.

Finally, it is possible for an action to satisfy and harm different interests of a stakeholder simultaneously. The effects of the actions included in the action plan are shown on the interest chart after they have been aggregated according to the data entered into the system as described above.

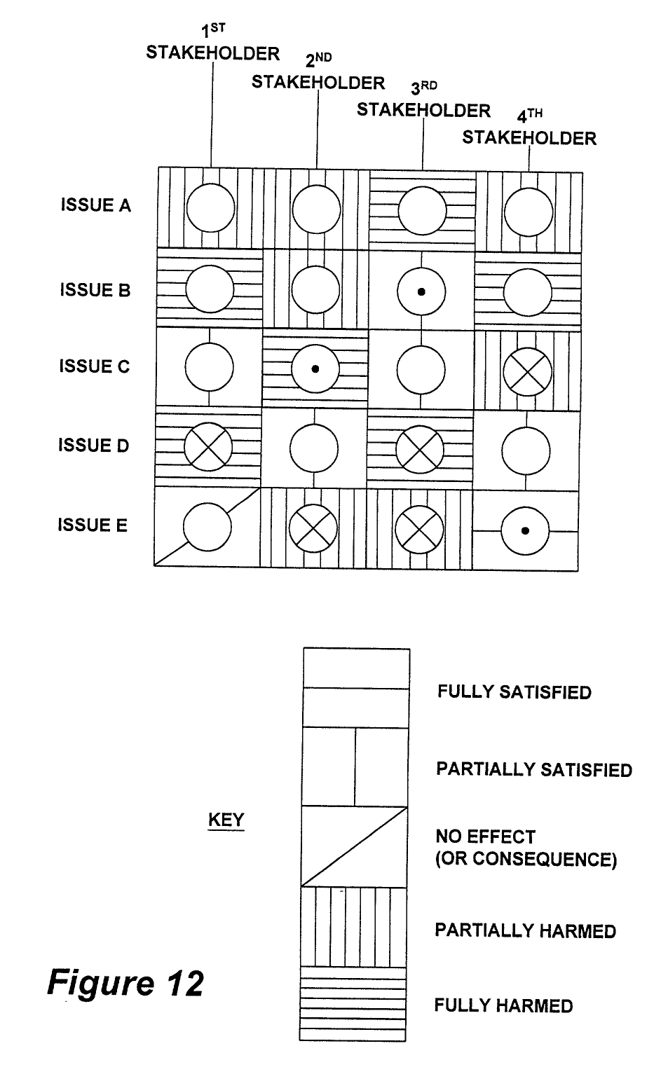

FIG. 12 shows the interest chart of FIG. 4 displaying the effects of the fighting alternative plans developed in the process described above. The aggregated effects of the stakeholders' fighting alternatives from all of the fighting alternative plans are shown on each interest with respect to each stakeholder on each issue. The effects follow the key shown in the figure. A fighting alternative may have no effect on an interest, may have some positive effect of partially satisfying an interest, or may satisfy the stakeholder's interest completely. Alternatively, the fighting alternative may be somewhat harmful or fully harmful to a stakeholder's interest on a given issue. Finally, it is possible for a fighting alternative to satisfy and harm different interests of a stakeholder simultaneously. The effects of the fighting alternatives included in the fighting alternative plans of all stakeholders are shown on the interest chart after they have been aggregated according to the data entered into the system as described above.

The actions selected for the draft action plans can be manipulated by the users on an ongoing basis to achieve outcomes desired by the users. For example, the users may consider including various actions in the draft action plans to see how those actions affect stakeholder interests in combination with other actions. Similarly, the users may try out various combinations of actions to see if such actions can maximize the satisfaction of stakeholder interests selected by the users and minimize the harm to stakeholder interests selected by the users, block 420. The actions selected by the users for the draft action plans can be removed from the draft action plans, the actions can be modified or the data about their effects on stakeholder interests can be modified, or other actions, including newly created actions, can be added to the draft action plans. Similarly, the fighting alternative plans can be modified by removing fighting alternatives from the fighting alternative plans, by modifying fighting alternatives or the data about their effects on stakeholder interests, or by adding other fighting alternatives, including newly created fighting alternatives, to the fighting alternative plans. The interest charts appear in a variety of formats that use color-coding, symbols, text and font styles to emphasize the relationship of stakeholders' interests to each other as well as to indicate the importance stakeholders place on each interest.

The system displays the above information on the interest chart of FIG. 11. The interest chart shows the effects of the actions, action plans, fighting alternatives, or fighting alternative plans on stakeholder interests. In addition, the system allows the users to compare simultaneously the individual effects of possible actions on the PAL of FIG. 6 with the aggregated effects of the draft action plan, as illustrated on the interest chart of FIG. 11, or as illustrated on bar graphs described below. That is, the users may simultaneously a) refer to the PAL to determine which actions to consider including the action plans, and b) view the aggregated effects of those actions included in the action plan on the interest chart or on a bar graph. This process of simultaneously using the PAL and interest chart is available to the users on an ongoing basis once the data required for generating the PAL and interest chart has been entered.

The system also displays the above information in color-coded bar graphs that emphasize the level of satisfaction (or harm) the action plans and fighting alternative plans will bring to specified interests and stakeholders, all of which may be selected by the users. The system provides a browse facility that enables the users to generate, view and manipulate the above bar graphs at any time after data required for generating the graphs has been entered into the system. Similarly, the system provides a browse facility that enables the users to generate, view and manipulate interest charts in various formats, PALS and other lists of stakeholders, issues, interests, actions, action plans, fighting alternatives and fighting alternative plans.

The users can select various possible actions, individually or in combination, and/or fighting alternatives, individually or in combination, so that the bar graphs and interest charts will display the effects of those actions and/or fighting alternatives on stakeholder interests chosen by the users. This enables the users to evaluate options through visual/graphic representation of the nature and magnitude of the consequences those options will have on the interests of the stakeholders.

The next step in evaluating options is to consider improving the action plans from the perspectives of various stakeholders, including (if applicable) the users, whose fighting alternative plans satisfy their critical and important interests more effectively than the actions selected for the action plans would. Where key stakeholders derive more satisfaction of their critical and important interests through pursuit of fighting alternatives than through negotiated agreement contemplated by the action plans, the action plans are unlikely to result in a negotiated agreement unless they are improved from the perspective of such stakeholders. The system highlights the areas of weakness in the draft action plans through the color-coded index of satisfaction and harm in the interest chart and bar graphs, and guides the users to consider actions that are more likely to satisfy the critical and important interests of key stakeholders and thereby result in a negotiated agreement.

When the action plans have been improved as much as possible by the users, the users may select and save a “final” action plan, or set of alternative action plans, against which the stakeholders' fighting alternative plans will be compared, block 425. The action plan or plans are only final to the extent the users choose not to improve them.

In this last step, the system is used to determine whether the action plans or the fighting alternative plans are the more effective approach to satisfying the users' interests. If the negotiated agreement contemplated by the action plans cannot be improved from the perspective of the users to satisfy their interests more effectively than the fighting alternative plans would, then the users would be better off not negotiating an agreement consistent with those action plans. In sum, the users can choose the strategy, whether through negotiated agreement or alternatives to negotiated agreement, that maximizes satisfaction of their interests on issues that are critical and important to them. Similarly, neutral facilitators or mediators can use the system to assist stakeholders in evaluating whether the stakeholders are better off agreeing to proposed action plans or pursuing fighting alternative plans.

Users can continuously evaluate and re-evaluate information, options and risk through the system to ensure that they maximize satisfaction of their critical and important interests and minimize harm to those same interests. Users can use the browse function provided by the system to modify and refine the stakeholders, issues, context and stakeholder values, possible actions and action plans, refine the fighting alternatives and fighting alternative plans, re-evaluate the interests of the stakeholders, and reevaluate the effects of the actions and fighting alternatives on those interests. The foregoing may be done on an unlimited basis. The system also assists users to identify areas on an ongoing basis where additional information may lead to the development of breakthrough strategies and circumvent apparent negotiating impasses. The system helps users: 1) anticipate the moves of others based on an understanding of the interests that motivate them; and 2) evaluate all options on an ongoing basis so as to maximize satisfaction of the users' interests.

In sum, the users will be in command of the information they need to make the right decisions for strategy planning, risk analysis and negotiations, considering the long and short term impacts of various possibilities and alternatives. The users will operate from a common base of information with a clear understanding not only of their own interests but also of the interests of others. As a result, the users will rarely be surprised by the positions, tactics or reactions of their negotiating counterparts. Instead, the users will be in a position to orchestrate discussions and negotiations so as to satisfy the interests of other stakeholders where appropriate, and maximize satisfaction of their own interests through either negotiated agreements or alternatives to negotiated agreement.

When the users have selected any strategies, such as action plans or fighting alternative plans, for implementation, the system provides a data porting facility that allows the users to port the data generated and maintained in the system during the planning session or negotiation to other information management systems, such as project planning systems or calendaring systems. The data stored by the system can also be used as a basis for generating assumptions to be included in financial models and can be compared with data from other systems for projecting outcomes and assessing risks, such as calculations of settlement values in litigation. The system can also be linked to other databases of information related to a planning session or negotiation so that the users can cross-reference data stored by the system with related data stored by other systems. If the users elect to conclude a planning session or negotiation at any point, the system allows the users to mark that planning session or negotiation as complete. The completed planning session or negotiation is then archived by the system for possible later use as model for a new session or negotiation.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A computer-implemented method for managing interest-based information, comprising the steps of:
receiving data about a plurality of stakeholders, a plurality of issues and a plurality of interests in relation to a transaction;
creating links among said plurality of stakeholders, said plurality of issues and said plurality of interests, said links indicating relationships with regard to said transaction;
receiving rating data rating each of said plurality of stakeholders in importance with respect to said transaction and each of said plurality of issues with respect to each of said plurality of stakeholders thereby producing a hierarchy of interests;
receiving a plurality of actions related to said transaction, said actions including effects data relating to said interests; and,
analyzing said plurality of actions according to a provided strategy to produce a plan having one or more of said plurality of actions effecting said strategy in said transaction.

2. The method of claim 1 further comprising the step of displaying said stakeholders, issues and interests in an interest chart.

3. The method of claim 2 wherein said interest chart shows stakeholders and issues arranged in response to said rating data.

4. The method of claim 1 wherein at least one said stakeholder is a person.

5. The method of claim 1 wherein said at least one said stakeholder is a legal entity.

6. The method of claim 1 wherein said at least one said stakeholder is a group of people.

7. The method of claim 1 wherein said issues are components of said transaction.

8. The method of claim 1 wherein said interests are outcomes related to said plurality of issues.

9. The method of claim 1 wherein said transaction is a negotiation.

10. The method of claim 1 wherein said transaction is a strategy planning session.

11. The method of claim 1 wherein the step of creating links further comprises the steps of:
identifying an anchor stakeholder in said plurality of stakeholders on each said issue; and,
comparing interests of non-anchor stakeholders to interests of said anchor stakeholder to determine interests with respect to said anchor stakeholder.

12. The method of claim 1 wherein said step of analyzing said plurality of actions further comprises the step of determining whether a particular action of said plurality is compatible with the other actions.

13. The method of claim 1 wherein said step of analyzing said plurality of actions further comprises the step of determining whether the effects of a particular action of said plurality of actions are cumulative with the effects of another action of said plurality of actions.

14. The method of claim 1 wherein said step of analyzing said plurality of actions further comprises the step of determining whether a particular action of said plurality of actions overrides another action of said plurality of actions.

15. The method of claim 1 further comprising the step of identifying one or more fighting alternatives if said analyzing step does not produce a plan acceptable to at least one stakeholder of said plurality of stakeholders.

16. An interest-based data management system, comprising:
a) a first database to store data about a plurality of stakeholders and issues in a transaction, said data including interests of each said plurality of stakeholders with regard to each said plurality of issues;
b) a second database to store data about possible actions to be taken in said transaction to satisfy said interests, said actions data including the effects of said actions on said interests; and
c) a processor to provide an optimized course of action, said optimized plan having a subset of said actions, said subset of actions determined from said data on effects of said actions on said interests.

17. The interest-based data management system of claim 16 wherein said transaction is a negotiation.

18. The interest-based data management system of claim 16 wherein said transaction is a strategy session.

19. The interest-based data management system of claim 16 wherein said transaction is a mediation.

20. The interest-based data management system of claim 16 wherein said first database further stores importance ratings of said interests with respect to each said stakeholder.

21. The interest-based data management system of claim 16 wherein said first database further stores importance ratings of each said stakeholder with respect to said transaction.

22. An interest-based data management system, comprising:
a) a first database to store data about a plurality of stakeholders and issues in a transaction, said data including interests of each said plurality of stakeholders with regard to each said plurality of issues;
b) a second database to store data about actions to be taken to satisfy said interests, said actions data including the effects of said actions on said interests; and
c) a processor to provide an interest chart from data stored in said first database and said second database, said interest chart showing consequences of said actions with regard to said issues and said plurality of stakeholders.

23. The interest-based data management system of claim 22 wherein said transaction is a negotiation.

24. The interest-based data management system of claim 22 wherein said transaction is a strategy planning session.

25. The interest-based data management system of claim 22 wherein said first database further stores relationships among said interests.

26. The interest-based data management system of claim 22 wherein said data of said second database further comprises cumulative effects of said actions on the interests of said stakeholders.

27. An interest-based data management system, comprising:
a) a first database to store data about a plurality of stakeholders and issues in a transaction, said data including interests of said plurality of stakeholders with regard to said plurality of issues and the importance of said interests with respect to said stakeholders;
b) a second database to store data about links among said stakeholders, issues and interests, said data indicating relationships with regard to said transaction; and
c) a processor to provide an interest chart from said data stored in said databases, said interest chart showing said plurality of stakeholders and issues so that issues on which stakeholders have interests in common are grouped together and issues on which stakeholders have interests opposed are grouped together, and showing the importance of said interests to said stakeholders and showing relationships among said interests.
